(19) United States
(12) Patent Application Publication
(10) Pub. No.: US 2017/0257510 A1
(43) Pub. Date: Sep. 7, 2017

(54) IMAGE FORMING APPARATUS, IMAGE FORMING SYSTEM, AND IMAGE FORMING METHOD

(71) Applicants: Tomohiro KUROYANAGI, Tokyo (JP); Jun SATOH, Tokyo (JP)

(72) Inventors: Tomohiro KUROYANAGI, Tokyo (JP); Jun SATOH, Tokyo (JP)

(73) Assignee: Ricoh Company, Ltd., Tokyo (JP)

(21) Appl. No.: 15/444,777

(22) Filed: Feb. 28, 2017

(30) Foreign Application Priority Data
Mar. 4, 2016 (JP) 2016-041829
Jun. 3, 2016 (JP) 2016-111737

(51) Int. Cl. H04N 1/00

(52) U.S. Cl. CPC H04N 1/00973; H04N 1/00204; H04N 1/00344; H04N 1/00347; H04N 1/00411; H04N 1/00464; H04N 2201/0094

(57) ABSTRACT

An image forming apparatus includes hardware resources including a scanner device and a printer device, a user interface including a display, a network interface, and a processor that causes the image forming apparatus to execute processes of a web browser and an image forming unit. The web browser includes an obtaining part that obtains web contents from a server. The web contents includes information pertaining to an operation screen of a copying process that uses the scanner device and the printer device and information pertaining to a script for controlling the copying process. The web browser includes a display control part that displays the operation screen on the display based on the web contents. The web browser part includes a script execution part that executes the script for controlling the copying process based on the information included in the web contents.

### CROSS-REFERENCE TO RELATED APPLICATIONS

The present application is based on and claims the benefit of priority Japanese Priority Application Nos. 2016-041829 and 2016-111737 filed on Mar. 4, 2016 and Jun. 3, 2016, respectively, with the Japanese Patent Office, the entire contents of which are hereby incorporated by reference.

### BACKGROUND OF THE INVENTION

1. Field of the Invention

The disclosure discussed herein relates to an image forming apparatus, an image forming system, and an image forming method.

2. Description of the Related Art

Using a web browser to display an operation screen on an image forming apparatus that performs an image forming process (e.g., copying) is known.

For example, Japanese Laid-Open Patent Publication No. 2011-124721 discloses a multifunction peripheral including a UI (User Interface) unit and a server unit. The multifunction peripheral uses a web browser of the UI unit to display an operation screen obtained from the server unit and controls operations by using an installed server unit to execute an application according to an operation performed on the operation screen.

According to the technology disclosed in Japanese Laid-Open Patent Publication No. 2011-124721, the image forming apparatus (multifunction peripheral) requires to install, for example, an application or a UI (User Interface) dedicated to the image forming apparatus in a case where a user, a developer, or the like requests the UI to be changed.

Further, the UI may be changed on the server side. In this case, a web application operated on the server side is used to display an operation screen on a browser of an image forming apparatus and control a copying function of the image forming apparatus. In this case, however, it is difficult for the server to provide an operation screen corresponding to each one of multiple image forming apparatuses that have different usable functions.

### SUMMARY OF THE INVENTION

According to an aspect of the disclosure discussed herein, there is provided an image forming apparatus, an image forming system, and an image forming method that substantially obviate one or more of the problems caused by the limitations and disadvantages of the related art.

Features and advantages of the disclosure are set forth in the description which follows, and in part will become apparent from the description and the accompanying drawings, or may be learned by practice of the disclosure according to the teachings provided in the description. Objects as well as other features and advantages of the disclosure will be realized and attained by an image forming apparatus, an image forming system, and an image forming method particularly pointed out in the specification in such full, clear, concise, and exact terms as to enable a person having ordinary skill in the art to practice the disclosure.

To achieve these and other advantages and in accordance with the purpose of the disclosure, as embodied and broadly described herein, the disclosure provides an image forming apparatus including multiple hardware resources including at least a scanner device and a printer device, a user interface including a display, a network interface configured to connected to a server apparatus via a network, and a processor that causes the image forming apparatus to execute processes of a web browser unit and an image forming unit. The web browser unit includes an obtaining part that obtains web contents from the server apparatus, the web contents including screen information pertaining to an operation screen of a copying process that uses the scanner device and the printer device and script information pertaining to a script for controlling the copying process, a display control part that displays the operation screen of the copying process on the display based on the web contents obtained by the obtaining part, and a script execution part that executes the script for controlling the copying process based on the script information included in the web contents obtained by the obtaining unit. The image forming unit includes an interface for receiving a request for controlling the copying process by the execution of the script for controlling the copying process by the script execution part. The image forming unit controls the copying process in response to the request received by the interface.

Other objects, features and advantages of the disclosure will become more apparent from the following detailed description when read in conjunction with the accompanying drawings.

### BRIEF DESCRIPTION OF THE DRAWINGS

FIG. 1 is a schematic diagram illustrating a configuration of an image forming system according to an embodiment of the present invention;

FIG. 2 is a schematic diagram illustrating a hardware configuration of a computer according to an embodiment of the present invention;

FIG. 3 is a schematic diagram illustrating a hardware configuration of an image forming apparatus according to an embodiment of the present invention;

FIG. 4 is a functional diagram of an image forming system according to an embodiment of the present invention;

FIG. 5 is a schematic diagram illustrating an operation screen based on web contents according to an embodiment of the present invention;

FIG. 6 is a sequence diagram illustrating a display process of an operation screen according to the first embodiment of the present invention;

FIGS. 7A-7C are schematic diagrams illustrating operation screens of an image forming apparatus according to the first embodiment of the present invention;

FIG. 8 is a sequence diagram illustrating a copying process according to the first embodiment of the present invention;

FIG. 9 is a schematic diagram illustrating a copy API according to the first embodiment of the present invention;

FIG. 10 is a sequence diagram illustrating a process of canceling a copying process according to the first embodiment of the present invention;

FIGS. 11A to 11C are schematic diagrams illustrating display screens of a copying process according to the first embodiment of the present invention;

FIG. 12 is a sequence diagram illustrating a process of displaying an operation screen according to the second embodiment of the present invention;

FIGS. 13A to 13D are schematic diagrams illustrating operation screens according to the second embodiment of the present invention;

FIG. 14 is a sequence diagram illustrating a copying process according to the third embodiment of the present invention;

FIGS. 15A to 15D are schematic diagrams illustrating display screens of a copying process according to the third embodiment of the present invention;

FIG. 16 is a sequence diagram illustrating a first part of a copying process according to the fourth embodiment of the present invention;

FIG. 17 is a sequence diagram illustrating a second part of a copying process according to the fourth embodiment of the present invention;

FIG. 18 is a schematic diagram illustrating a standby screen of a next document according to the fourth embodiment of the present invention;

FIG. 19 is a sequence diagram illustrating an initial setup process according to the fifth embodiment of the present invention;

FIGS. 20A-20C are schematic diagrams illustrating initial setup screens according to the fifth embodiment of the present invention;

FIG. 21 is a schematic diagram illustrating an image of web contents according to an embodiment of the present invention;

FIG. 22 is a schematic diagram illustrating an image of web contents according to another embodiment of the present invention;

FIG. 23 is a functional diagram illustrating an image forming system according to the sixth embodiment of the present invention;

FIGS. 24A and 24B are schematic diagrams illustrating information managed by a server apparatus according to the sixth embodiment of the present invention;

FIG. 25 is a sequence diagram illustrating a copying process according to the sixth embodiment of the present invention;

FIGS. 26A and 26B are schematic diagrams illustrating display screens of an information terminal according to the sixth embodiment of the present invention;

FIG. 27 is a sequence diagram illustrating another copying process according to the sixth embodiment of the present invention; and

FIGS. 28A and 28B are schematic diagrams illustrating display screens of an information terminal according to the sixth embodiment of the present invention.

### DETAILED DESCRIPTION OF EMBODIMENTS

Next, embodiments of the present invention are described with reference to the accompanying drawings.

### <Configuration of Image Forming System>

First, a configuration of an image forming system according to an embodiment of the present invention is described.

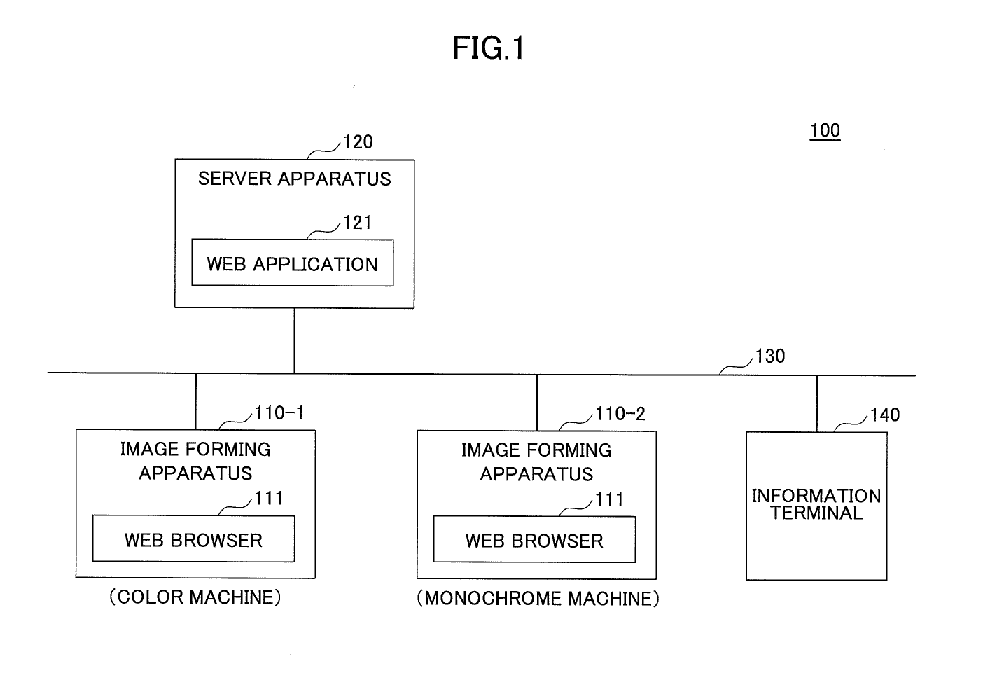

FIG. 1 is a schematic diagram illustrating a configuration of an image forming system 100 according to an embodiment of the present invention.

The image forming system 100 includes, for example, a server apparatus 120 and multiple image forming apparatuses 110-1, 110-2 connected to the server apparatus 120 via a network 130 (e.g., the Internet, LAN (Local Area Network)). Further, the image forming system 100 may also include an information terminal 140 connected to the server apparatus 120 and the image forming apparatuses 110-1, 110-2 via the network 130. The server apparatus 120, the image forming apparatuses 110-1, 110-2, and the information terminal 140 wirelessly connected or connected by a cable or the like. Note that the multiple image forming apparatuses 110-1, 110-2 may be collectively referred to as “image forming apparatus 110” in a case of describing a given image forming apparatus among the multiple image forming apparatuses 110-1, 110-2.

The number of the image forming apparatuses 110 is not limited to the number of image forming apparatuses illustrated in FIG. 1. That is, a given number of image forming apparatuses 110 may be included in the image forming system 100. Further, each of the multiple image forming apparatuses 110 may have different functions. In the example illustrated in FIG. 1, the image forming apparatus 110-1 may be a color copier capable of performing color copying (color printing) whereas the image forming apparatus 110-2 may be a monochrome copier capable of performing monochrome copying (monochrome printing) and unable to perform color copying (color printing).

The server apparatus 120 may be a system including, for example, one or more information processing apparatuses having a web server function. The server apparatus 120 provides web contents to one or more image forming apparatuses 110 by using a web application (hereinafter also referred to as “web-app”) 121. The web contents provided by the server apparatus 120 includes, for example, information pertaining to an operation screen for a copying process, a script for controlling the copying process, or link information of the script.

The image forming apparatus 110 may be a multifunction peripheral having multiple functions such as a scanning function, a printing function, a copying function, and a facsimile function. The image forming apparatus 110 may also be an electronic device having a single function such as a copying function. The image forming apparatus 110 of this embodiment can also obtain web contents from the web application 121 of the server apparatus 120 and display a control panel for performing a copying function or the like by using the obtained web contents.

The image forming apparatus 110 also includes a web API (Application Programming Interface) capable of using, for example, various functions pertaining to a copying process by using the web application 121 of the server apparatus 120 or a web browser 111 of the image forming apparatus 110.

The web contents provided by the server apparatus 120 includes a script (e.g., Java®) for controlling various functions pertaining to the copying process by using the web API of the image forming apparatus 110.

With the above-described configuration, the image forming apparatus 110 of this embodiment can display, for example, an operation screen for a copying process on an operation panel or the like by using the web contents obtained from the server apparatus 120.

Preferably, the image forming apparatus 110 executes a script included in the web contents obtained from the server apparatus 120, so that the image forming apparatus 110 can, by way of the web API, obtain information pertaining to the functions usable for the image forming apparatus 110 and display an operation screen corresponding to the image forming apparatus 110.

When the image forming apparatus 110 receives an operation for performing a copying process (copy operation) from the operation screen displayed on the operation panel or the like, the image forming apparatus 110 executes a script of a copying function included in the web contents and uses the web API to control the copying process of the image forming apparatus 110.

Thus, according to the image forming system 100 of this embodiment, each image forming apparatus 110 displays an operation by using web contents provided by the web application 121 of the server apparatus 120. Thereby, an administrator of the image forming system 100 can easily change the operation screen of multiple image forming apparatuses 110-1, 110-2 by updating the web application 121 of the server apparatus 120.

Further, according to the image forming system 100, the web browser 111 of the image forming apparatus 110 controls, for example, a copying process of the image forming apparatus 110 by executing a script included in the web contents. Accordingly, when the image forming apparatus 110 receives a copying operation from the user, the image forming apparatus 110 can execute a copying process without relying on the web application 121 of the server apparatus 120.

Hence, according to the above-described embodiment of the present invention, the image forming system 100 including multiple image forming apparatuses 110-1, 110-2 can prevent the processing rate from decreasing and facilitate the changing of the operation screen of the imager forming apparatus 110.

The configuration of the image forming system 100 illustrated in FIG. 1 is merely an example. The image forming system 100 may have various configurations besides the configuration illustrated in FIG. 1.

For example, the image forming system 100 may include a storage server or the like in which a script for controlling a copying process of the image forming apparatus 110 is stored. In this case, the web contents provided by the server apparatus 120 includes reference information of the script for controlling the copying process instead of the script for controlling the copying process. Further, the image forming apparatus 110 may obtain the script, that is identified by the reference information included in the web contents obtained from the server apparatus 120, from the storage server or the like.

Further, the web API included in the image forming apparatus 110 may be an API other than a web API. That is, the web API is not limited to a web API that can use various functions pertaining to the copying process by way of the web browser 111 or the like of the image forming apparatus 110.

Further, the function of the server apparatus 120 may be a function provided by a cloud service or the like.

### <Hardware Configuration>

### <Hardware Configuration of Computer>

The server apparatus 120 is implemented by one or more information processing apparatuses each of which including a hardware configuration of a typical computer. Next, an example of a hardware configuration of a computer 200 is described.

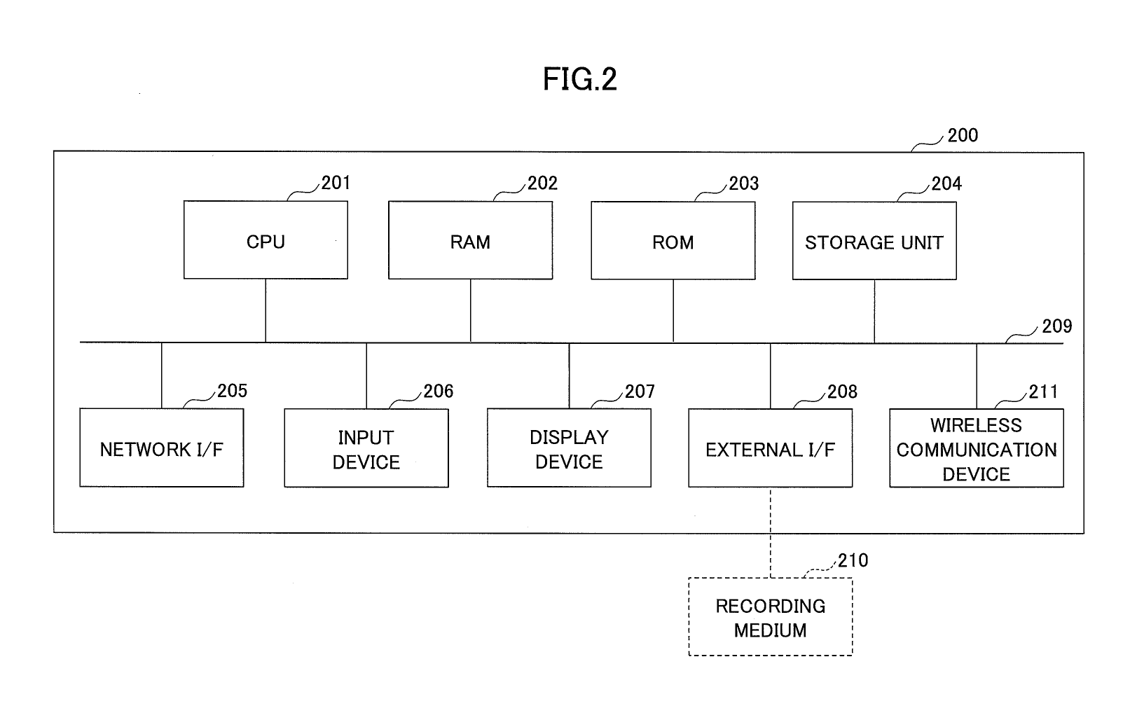

FIG. 2 is a schematic diagram illustrating an example of a hardware configuration of a computer according to an embodiment of the present invention.

The computer 200 includes, for example, a CPU (Central Processing Unit) 201, a RAM (Random Access Memory) 202, a ROM (Read Only Memory) 203, a storage unit 204, a network I/F 205, an input device 206, a display device 207, an external I/F 208, and a bus 209.

Further, the computer 200 may also include a wireless communication device 211 for performing wireless communications with another computer or the image forming apparatus 110.

The CPU 201 is an arithmetic device that implements various functions of the computer 200 by reading out programs and data stored in the ROM 203 or the storage unit 204, loading the programs and data to the RAM 202, and executing various processes according to the programs and data. The RAM 202 is a volatile memory used as a work area of the CPU 201. The ROM 203 is a non-volatile memory in which programs and data are stored even in a state where electric power of the computer 200 is turned off.

The storage unit 204 is a storage device having large storage capacity such as a HDD (Hard Disk Drive) or an SSD (Solid State Drive). For example, an OS (Operation System), an application program, and various data are stored in the storage unit 204.

The network I/F 205 is a communication interface for connecting the computer 200 to a network 130.

The input device 206 is an input device such as a pointing device (e.g., mouse) or a keyboard. The input device 206 is an input unit used for inputting various operation signals into the computer 200.

The display device 207 is, for example, a display (display unit) that displays process results or the like of the computer 200.

The external I/F 208 is an interface serving as an interface between the computer 200 and an external device. The external device may be, for example, a recording medium 210. For example, in a case where a predetermined program is stored in the recording medium 210, the computer 200 can execute the predetermined program by installing the predetermined program in the computer 200 via the external I/F 208.

The bus 209 that is connected to each of the above-described devices and units illustrated in Fig. transmits, for example, an address signal, a data signal, and various control signals.

The wireless communication device 211 is a communication device that performs wireless communications with another computer or the image forming apparatus 110. The wireless communications performed by the wireless communication device 211 may be, for example, wireless LAN (Local Area Network) communication, wireless PAN (Personal Area Network) communication, infrared communication, and sonic communication.

Note that the configuration illustrated in FIG. 2 is merely an example. For example, devices such as the input device 206 or the display device 207 may be provided outside of the computer 200.

### <Hardware Configuration of Image Forming Apparatus>

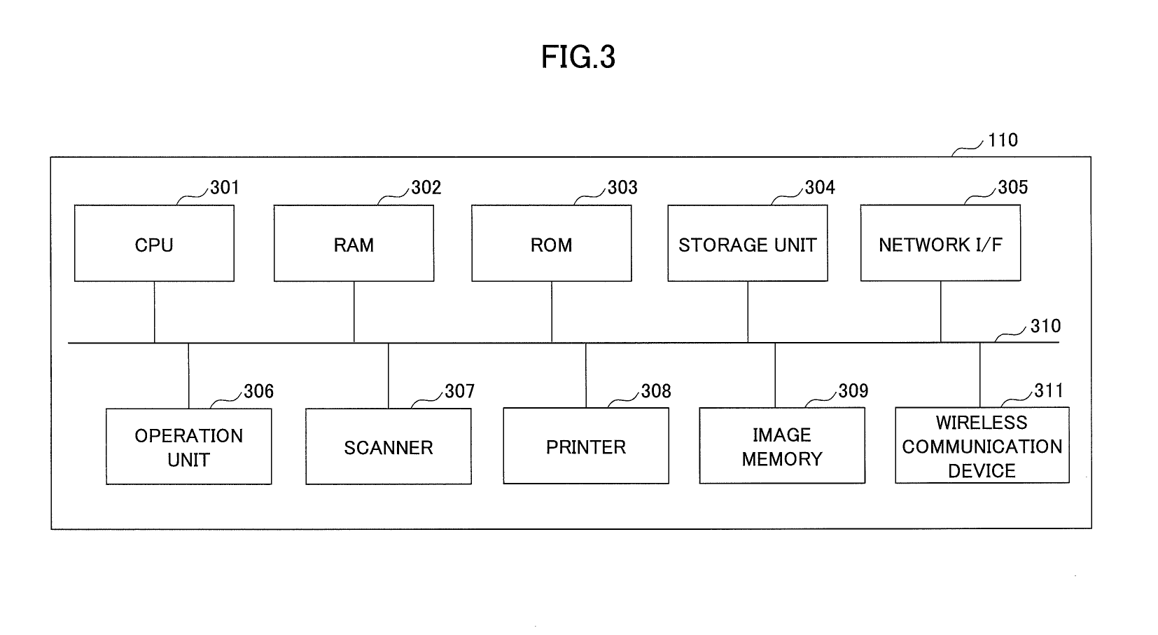

FIG. 3 is a schematic diagram illustrating a hardware configuration of the image forming apparatus 110 according to an embodiment of the present invention. The image forming apparatus 110 has a configuration of a typical computer. The image forming apparatus 110 includes, for example, a CPU 301, a RAM 302, a ROM 303, a storage unit 304, a network I/F 305, an operation unit 306, a scanner 307, a printer 308, an image memory 309, and a bus 310.

Further, the image forming apparatus 110 may also include, for example, a wireless communication device 311 for performing wireless communications with another image forming apparatus 110 or a computer such as the information terminal 140.

The CPU 301 is an arithmetic device that implements various functions of the image forming apparatus 110 by reading out programs and data stored in the ROM 303 or the storage unit 304, loading the programs and data to the RAM 302, and executing various processes according to the programs and data. The RAM 302 is a volatile memory used as a work area of the CPU 301. The ROM 303 is a non-volatile memory in which programs and data are stored even in a state where electric power of the image forming apparatus 110 is turned off.

The storage unit 304 is a storage device having large storage capacity such as a HDD (Hard Disk Drive) or an SSD (Solid State Drive). For example, an OS (Operation System), an application program, and various data are stored in the storage unit 304.

The network I/F 305 is a communication interface for connecting the image forming apparatus 110 to the network 130.

The operation unit 306 is an input display device including an input device part (e.g., touch panel) for receiving an input operation of a user and a display device part (e.g., LCD (Liquid Crystal Display)) for displaying an image or the like. The operation unit 306 may have a configuration of a typical computer (e.g., CPU, RAM, ROM, storage unit, network I/F). Thus, the operation unit 306 may be capable of executing a program such as a web browser.

The scanner 307 is a reading device that reads an image from a document and converts the read image into image data. The printer 308 is a printing device that prints image data. The image memory 309 is a memory used as a work area for processing an image during, for example, an image reading process, a printing process, or a copying process. The bus 310 that is connected to each of the devices and units illustrated in FIG. 3 transmits, for example, an address signal, a data signal, and various control signals.

The wireless communication device 311 is a communication device that performs wireless communications with another image forming apparatus 110 or another computer such as the information terminal 140. The wireless communications performed by the wireless communication device 211 may be, for example, wireless LAN (Local Area Network) communication, wireless PAN (Personal Area Network) communication, infrared communication, and sonic communication.

### <Functional Configuration>

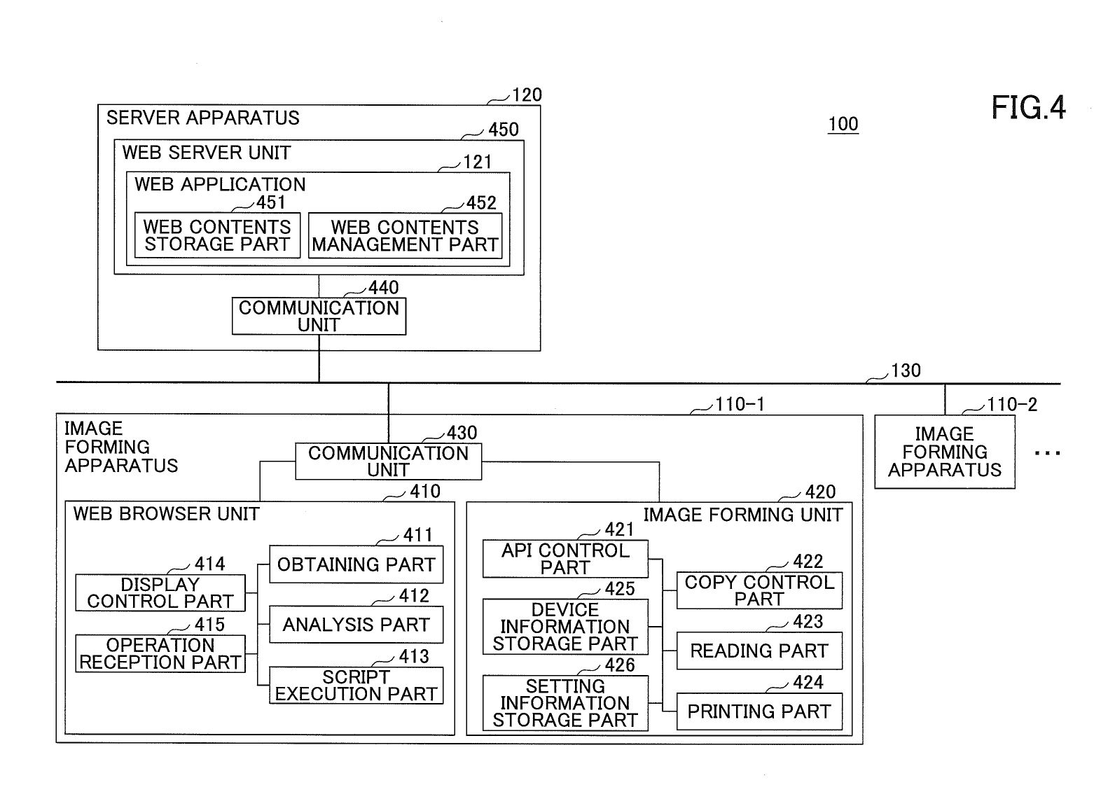

FIG. 4 is a schematic diagram illustrating a functional configuration of the image forming system 100 according to an embodiment of the present invention. The image forming system 100 illustrated in FIG. 4 corresponds to the image forming system 100 illustrated in FIG. 1. Thus, the image forming system 100 includes the server apparatus 120 and multiple image forming apparatuses 110-1, 110-2.

### <Functional Configuration of Server Apparatus>

The server apparatus 120 includes a communication unit 440 and a web server unit 450.

The communication unit 440 performs communications with multiple image forming apparatuses 110-1, 110-2 connected to the network 130. For example, the communication unit 440 may be implemented by a program that is executed by way of the network I/F 205 and the CPU 201 illustrated in FIG. 2.

The web server unit 450 is a web server that is implemented by, for example, a program of a web server that is executed by way of the CPU 201 illustrated in FIG. 2. Further, according to the web server unit 450 of the first embodiment, a web contents unit 451 and a web contents management unit 452 are implemented by way of the web application 121.

The web contents storage unit 451 is a storage unit that stores web contents therein. For example, the web contents include information pertaining to an operation screen of a copying process of the image forming apparatus 110 and a script for controlling the copying process. Alternatively, reference information of the script (e.g., link information) may be included in the web contents instead of the script for controlling the copying process.

The web contents management unit 452 may be a management unit that provides web contents stored in the web contents storage unit 451 to the image forming apparatus (request source) 110 in response to a request from the image forming apparatus 110.

According to the server apparatus 120 having the above-described configuration, the server apparatus 120 provides web contents (including information of an operation screen of a copying process and a script for controlling the copying process, or reference information of the script) to the image forming apparatus 110 in response to a request from the image forming apparatus 110.

### <Functional Configuration of Image Forming Apparatus>

The image forming apparatus 110 (image forming apparatuses 110-1, 110-2) includes a web browser part 410, an image forming unit 420, and a communication unit 430.

The web browser part 410 is implemented by executing a program of a web browser by operating, for example, the operation unit 306 included in the image forming apparatus 110. Alternatively, the web browser part 410 may be implemented by executing a program of a web browser by operating, for example, the CPU. 301 included in the image forming apparatus 110 of FIG. 3. The web browser part 410 includes, for example, an obtaining part 411, an analysis part 412, a script execution part 413, a display control part 414, and an operation reception part 415.

The obtaining part 411 obtains web contents from the server apparatus 120. The web content includes information pertaining to an operation screen of a copying process and information pertaining to a script for controlling the copying process. Note that the script for controlling the copying process includes, for example, a script for controlling a copying process (first script) or reference information pertaining to a script for controlling a copying process (second script).

The analysis part 412 analyzes the web contents obtained by the obtaining part 411 and notifies, for example, the information pertaining to the operation screen of the copying process included in the web contents to the display control part 414. Further, the analysis part 412 analyzes the web contents obtained by the obtaining part 411 and notifies, for example, the script for controlling the copying process included in the web contents to the script execution part 413. Note that, in a case where the web contents includes reference information of a script for controlling a copying process instead of the script for controlling a copying process (or includes both a script for controlling a copying process and reference information of the script for controlling a copying process), the analysis part 412 obtains the script by using the reference information and notifies the obtained script to the script execution part 413. At least a part of the functions of the analysis part 412 may be included in the script execution part 413.

The script execution part 413 executes the script for controlling the copying process notified by the analysis part 412. That is, the script execution part 413 executes the script for controlling the copying process based on the information pertaining to the script for controlling the copying process included in the web contents obtained by the obtaining part 411.

The display control part 414 displays an operation screen (e.g., copy application screen) on the operation unit 301 based on the web contents obtained by the obtaining part 411. For example, the display control part 414 displays an operation screen for a copying process on the operation unit 306 according to the information pertaining to the operation screen of the copying process notified by the analysis part 412 and information obtained as a result of the script executed by the script execution part 413.

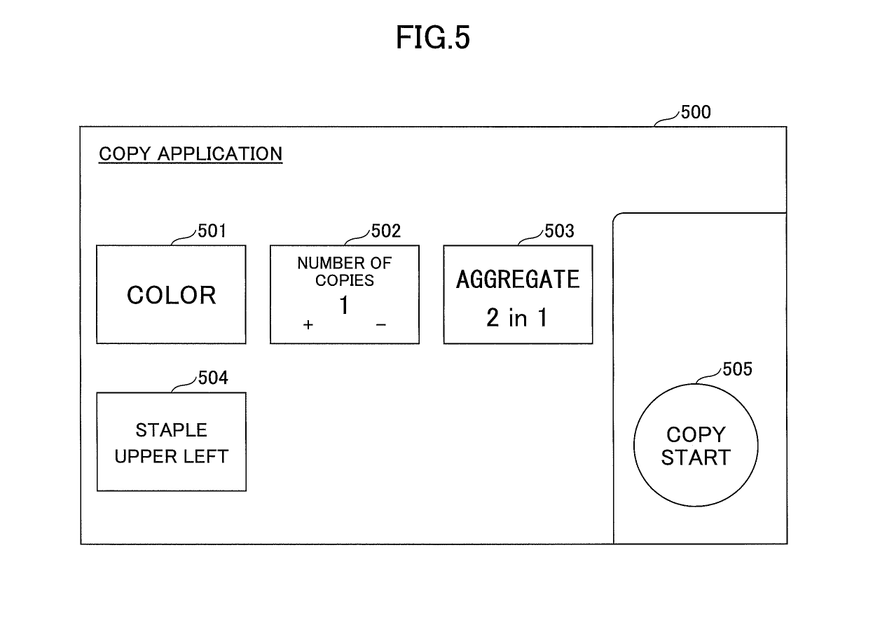

The operation reception part 415 receives an operation performed on the operation unit 306 by a user. For example, in a case where an operation screen of a copying process is selectably displayed on the operation unit 306 by the display control part 414, the operation reception part 415 receives a selection (selection operation) performed on the operation screen by the user. FIG. 5 illustrates an example of an operation screen of a copying process displayed on the operation unit 306 by the display control part 414.

FIG. 5 is a schematic diagram illustrating an example of an operation screen 500 based on web contents according to an embodiment of the present invention. The operation screen of a copying process (hereinafter also referred to as “copying process operation screen” or “copy application screen”) 500 is formed by web contents such as HTML (Hyper-Text Markup Language) and CSS (Cascading Style Sheets).

Further, the copy process operation screen 500 displays a UI (User Interface) that can easily switch a layout or a language by rereading CSS or a JSON (Javascript Object Notation).

The copying process operation screen 500 includes various setting buttons such as a button 501 for setting color/monochrome copying process, a button 502 for setting the number of copies, a button 503 for setting aggregate printing, and a button 504 for setting the stapling of copies. When one of the various setting buttons is selected by a user, the script execution part 413 selects a script corresponding to the selected setting button from the scripts for controlling the copying process and executes the selected script. Thereby, the value of a setting (setting value) can be changed by the user.

Further, the copying process operation screen 500 also includes a copy start button 505 for executing a copying process. When the copy start button 505 is selected, the script execution part 413 selects a script for executing a copying from the scripts for controlling the copying process and executes the selected script based on the setting value set with the various setting buttons. The script for executing the copying process includes, for example, an API which is a command for requesting the image forming unit 420 to execute the copying process.

### <Image Forming Unit>

The image forming unit 420 includes, for example, an API control part 421, a copy control part 422, a reading part 423, a printing part 424, a device information storage part 425, and a setting information storage part 426.

The API control part 421 is an interface that receives various requests (API) pertaining to the controlling of a copying process by executing a script for controlling the copying process with the script execution part 413 of the web browser part 410. Then, the API control part 421 reports the reception of the request to, for example, the copy control part 422. The API control part 421 is implemented by, for example, a program executed by the CPU 301 of FIG. 3.

The copy control part 422 controls a process pertaining to a copying process. For example, the copy control part 422, in response to the request reported from the API control part 421, performs a copying process by using the reading part 423 and the printing part 424. Further, the copy control part 422 stores capability information (i.e., information indicating the functions that can be used by the image forming unit 420) into the device information storage part 425. In addition, the copy control part 422 stores setting data (e.g., information pertaining to initial settings) of the image forming unit 420 into the setting information storage part 426 and manages the setting data.

The copy control part 422 is implemented by, for example, a program executed by the CPU 301 of FIG. 3.

The reading part 423 executes the reading of a document according to the controls of the copy control part 422. The reading part 423 is implemented by, for example, the scanner 307 of FIG. 3 along with a program executed by the CPU 301 of FIG. 3.

The printing part 424 executes a printing process according to the controls of the copy control part 422. The printing part 424 is implemented by, for example, the printer 308 of FIG. 3 along with a program executed by the CPU 301 of FIG. 3.

The device information storage part 425 stores capability information (i.e., information indicating the functions that can be used by the image forming unit 420) therein. The device information storage part 425 is implemented by, for example, the storage unit 304 of FIG. 3 along with a program executed by the CPU 301 of FIG. 3. Note that the capability information includes, for example, information pertaining to the configuration of a peripheral device (optional device) of the image forming apparatus 110, information pertaining to the functions and specifications of the image forming apparatus 110.

The setting information storage part 426 stores setting data (e.g., information pertaining to initial settings) of the image forming apparatus 110 therein. The setting information storage part 426 is implemented by, for example, the storage unit 304 of FIG. 3 along with a program executed by the CPU 301 of FIG. 3.

According to the above-described configuration, the image forming unit 420 has an interface for receiving a request for controlling the copying process by the execution of a script (script for controlling the copying process) by the script execution part 413. Thus, the image forming unit 420 controls the copying process in response to the request received by the interface.

### <Flow of Image Forming Method>

Next, an example of the flow of an image forming method of the image forming system 100 is described.

### First Embodiment

### <Display Process of Operation Screen>

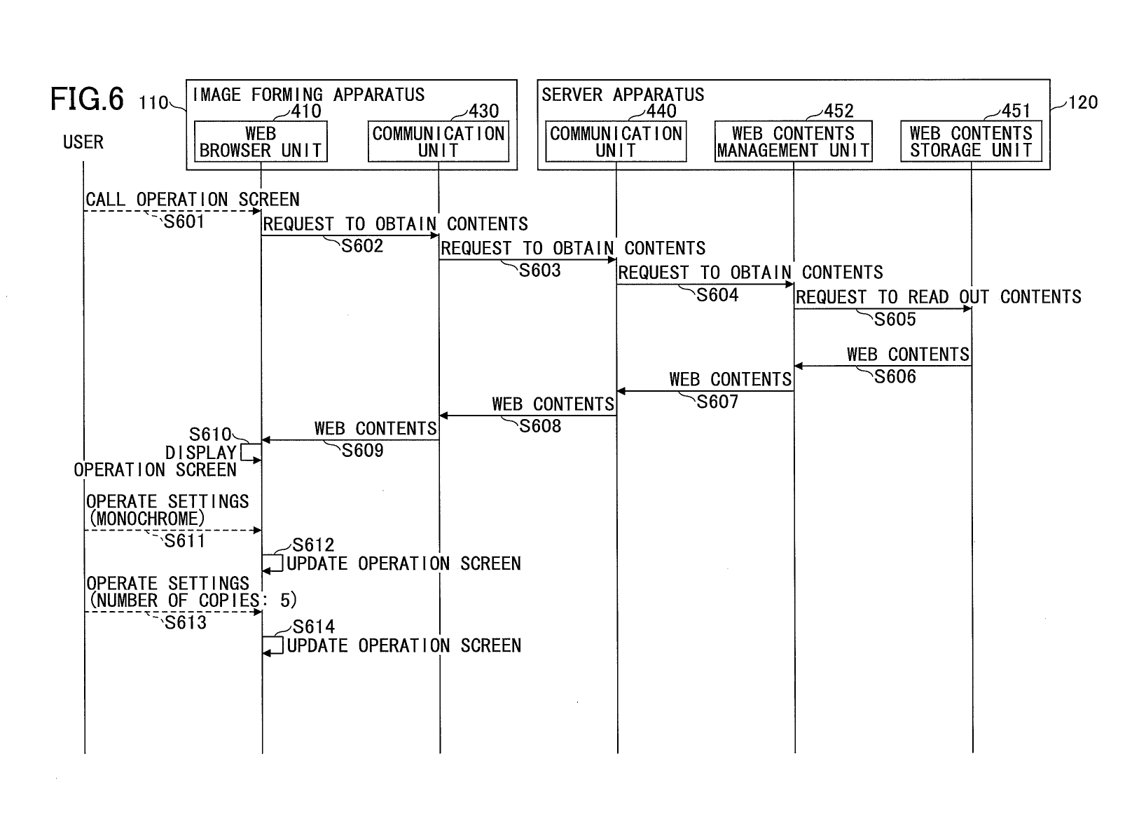

FIG. 6 is a sequence diagram illustrating a process of displaying an operation screen according to the first embodiment. Note that the broken line arrow of FIG. 6 indicates user's operation performed on the image forming apparatus 110.

In Step S601, the user performs an operation of calling for an operation screen of a copying process. For example, the user calls for the operation screen of the copying process by selecting an icon of a copying application with a web browser displayed on the operation part 306.

In Step S602, the obtaining part 411 of the web browser part 410 transmits a contents obtaining request to the server apparatus 120 via the communication part 430 when the operation reception part 415 receives the operation for calling the operation screen by the user.

When the communication unit 440 of the server apparatus 120 receives the contents obtaining request from the image forming apparatus 110 in Step S603, the communication unit 440 reports (notifies) the received contents obtaining request to the web contents management part 452 in Step S604.

In Steps S605 and S606, the web contents management part 452 reads out the web contents of the operation screen of the copying process from the web contents storage part 451.

In Step 5607, the web contents management part 452 transmits the read out web contents to the image forming apparatus (request source) 110 via the communication unit 440.

When the communication part 430 of the image forming apparatus 110 receives the web contents from the server apparatus 120 in Step S608, the communication part 430 reports the received web contents to the web browser 410 in Step S609.

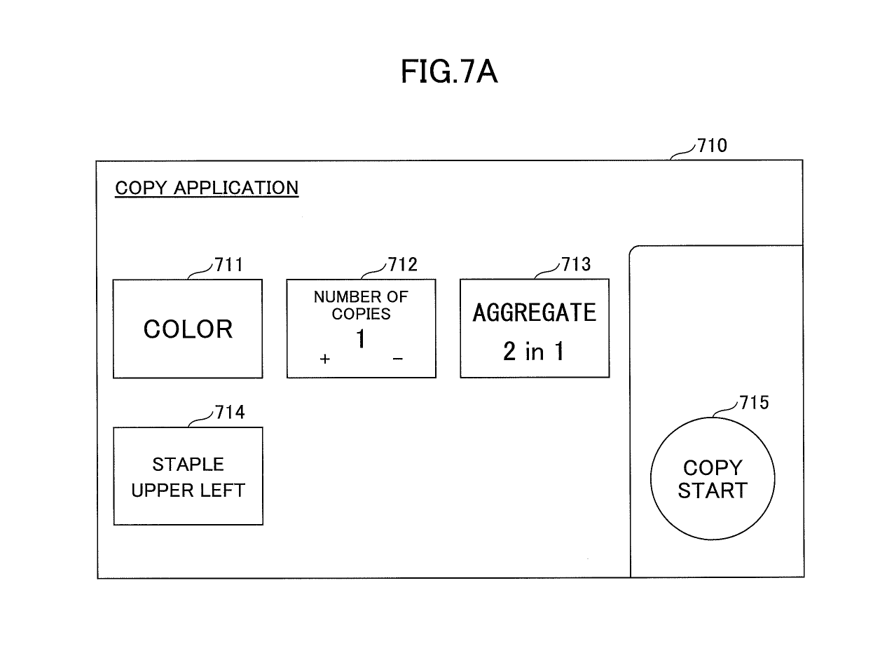

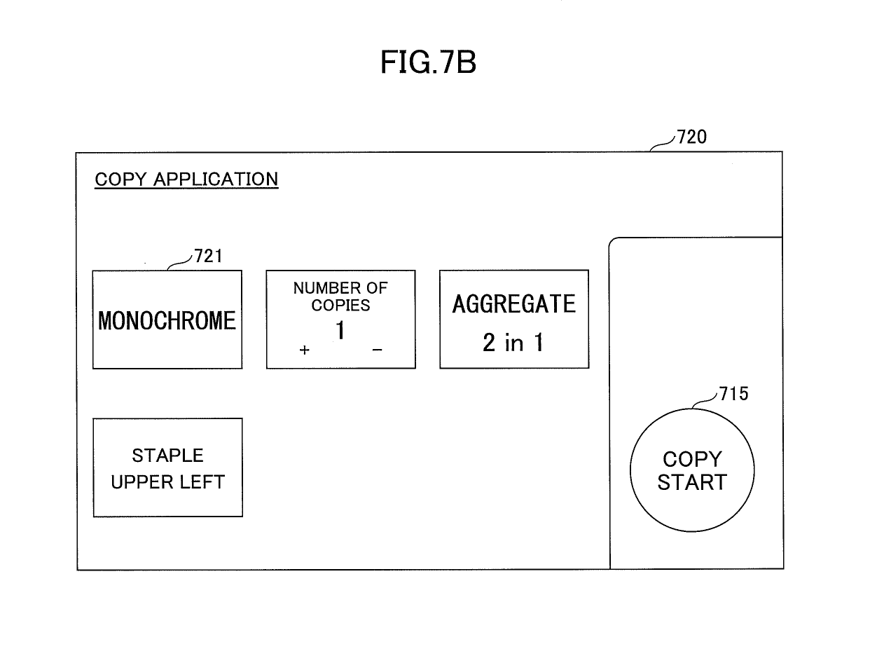

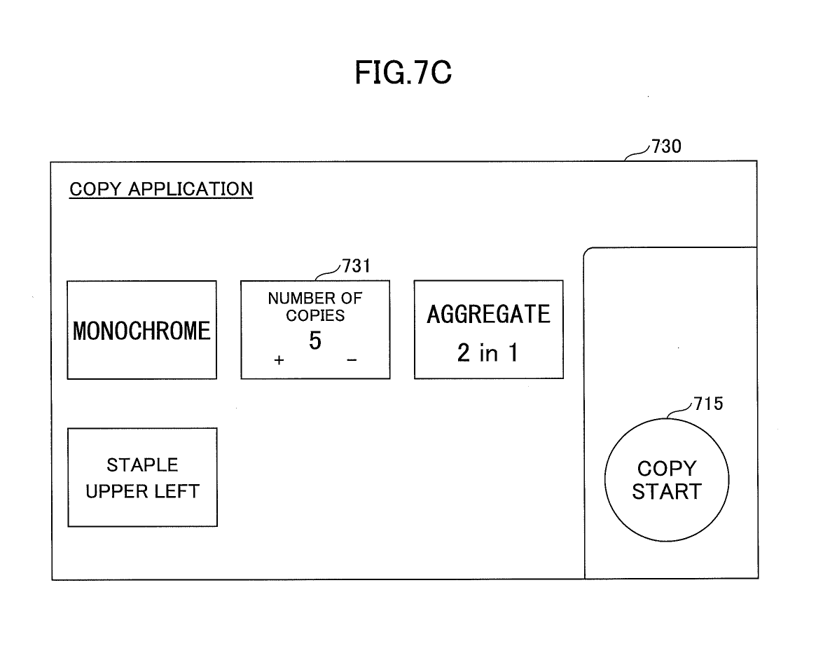

In Step S610, the display control part 414 of the web browser 410 displays the operation screen of the copying process on the operation part 306 based on the web contents received from the server apparatus 120 in Step S610. An example of the operation screen of the copying process displayed on the operation part 306 in Step S610 is illustrated FIG. 7A.

In the example of FIG. 7A, an operation screen 710 of the copying process displays various setting buttons such as a button 711 for setting a color/monochrome copying process, a button 712 for setting the number of copies, and a button 713 for setting the type of aggregate printing. Further, the current setting value is displayed on each setting button. For example, the button 711 for setting the color/monochrome copying process indicates that the color of the copying process is currently set to “color”. Further, the button 712 for setting the number of copies indicates that the number of copies to be copied is currently set to “one (1) copy”.

In Step S611 of FIG. 6, it is assumed that the user performs an operation of selecting the button 711 for setting the color/monochrome copying process and changing the color settings from “color” to “monochrome”.

When the operation reception part 415 of the web browser part 410 receives the user's operation in Step S612, the display control part 414 updates the operation screen of the copying process displayed on the operation part 306 in response to the user's operation performed on the web browser. An example of the operation screen of the copying process displayed on the operation part 306 in Step S612 is illustrated FIG. 7B.

In the example of FIG. 7B, the button 721 for setting the color/monochrome copying process on the operation screen 720 of the copying process is changed to the color setting “monochrome”.

In Step S613, it is assumed that the user performs an operation of selecting the button 712 for the number of copies and setting the number of copies to “5 copies”.

When the operation reception part 415 of the web browser part 410 receives the user's operation in Step S614, the display control part 414 updates the operation screen of the copying process displayed on the operation part 306 in response to the user's operation. FIG. 7C illustrates an example of the operation screen of the copying process displayed on the operation part 306 in Step S614. In the example of FIG. 7C, the button 731 for setting the number of copies on the operation screen 720 of the copying process is changed to the setting “5 copies”.

Accordingly, the user can change the setting values of the copying process by operating the operation screen of the copying process displayed on the operation part 306. Note that the changing of the setting value of the copying process is implemented by, for example, executing, by way of the script execution part 413, a script that is included the scripts for controlling the copying process and corresponds to the selected setting button.

### <Copying Process>

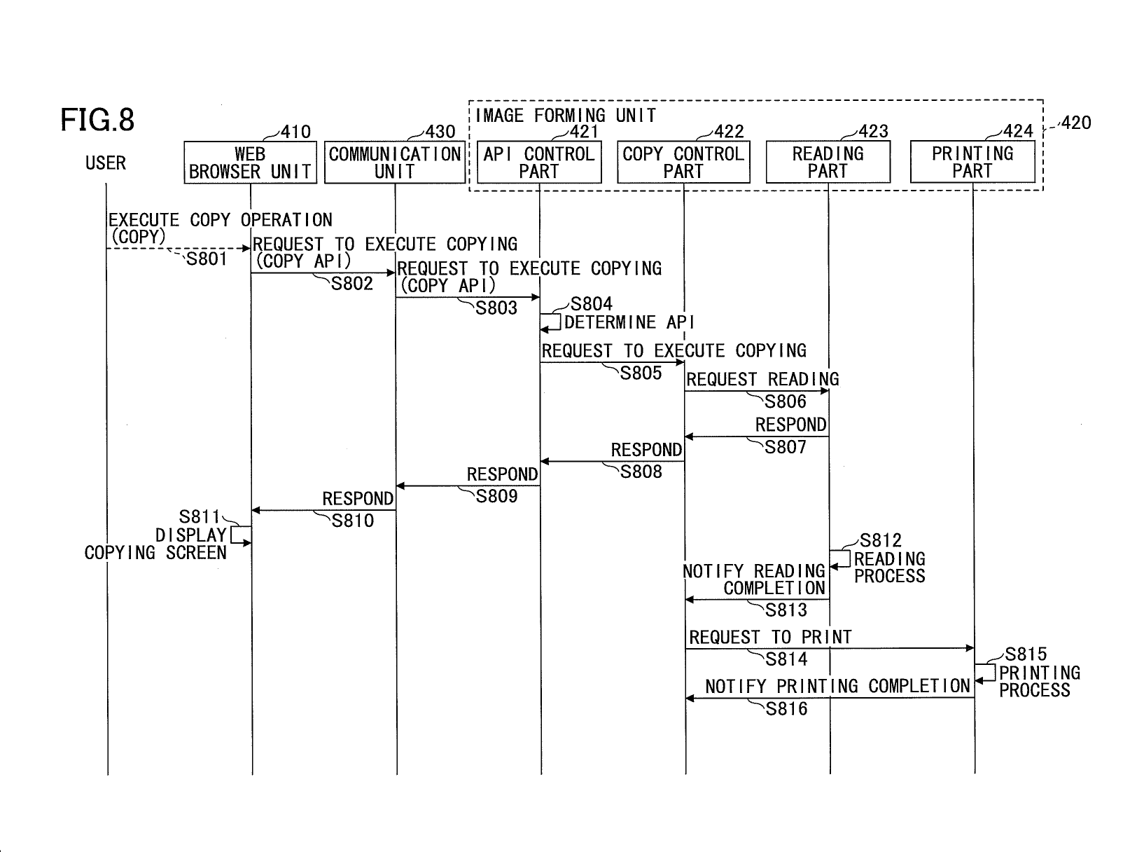

FIG. 8 is a sequence diagram illustrating an example of a copying process according to the first embodiment of the present invention.

In Step S801, an operation for executing a copying process is started when the user selects a copy start button 715 displayed in the operation screens 710, 720, 730 of the copying process as illustrated in FIG. 7A-7C.

When the operation reception part 415 receives the user's operation, the web browser part 410 transmits a copy execution request (copy API) to the image forming unit 420 via the communication part 430 in Step 5802 for requesting the script execution part 413 to execute the copying process.

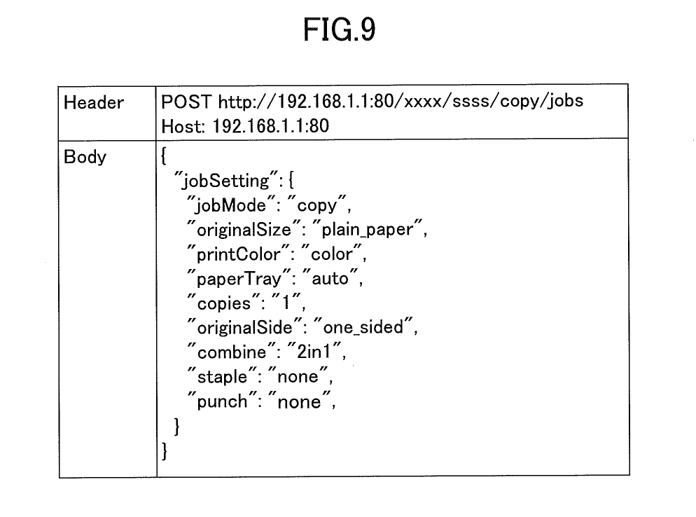

For example, among the scripts for controlling the copying process, the script execution part 413 executes a script corresponding to the copy start button 715 and transmits a copy API to the image forming unit 420 by way of a protocol such as HTTP or HTTPS. An example of the copy API transmitted by the script execution part 413 is illustrated in FIG. 9.

FIG. 9 is a schematic diagram illustrating an example of the copy API according to the first embodiment of the present invention. The copy API of FIG. 9 designates a POST command according to REST (Representational State Transfer) and a URI (Uniform Resource Identifier) and instructs the execution of the copying process. The setting values of the copying process are set as the Body information of the copy API.

When the image forming unit 420 receives the copy execution request (copy API) from the web browser part 410 in Step 5803 of FIG. 8, the API control part 421 determines whether the format of the received copy execution request is an API format that is set beforehand (Step S804).

In a case where the received copy execution request is determined to be the format that is set beforehand (e.g., the format of copy API illustrated in FIG. 9), the API control part 421 reports the copy execution request to the copy control part 422 based on the received copy API in Step S805.

In Step S806, the copy control part 422 that has received the copy execution request from the API control part 421 starts a copying process. For example, the copy control part 422 transmits an instruction instructing the reading part 423 to read a document.

In Step S807, the reading part 423 that has received the reading request transmits a response message indicating the reception of the reading start request in response to the reading start request.

In Steps S808-S810, response messages indicating the receptions of the copy execution requests are sequentially transmitted from the copy control part 422 to the web browser part 410.

In Step S811, the display control part 414 of the web browser part 410 displays, for example, the copy executing screen (i.e., a screen indicating that a copying process is being executed) on the operation part 306.

In Step S812, the reading part 423 that has received the reading request performs a reading process. For example, the reading part 423 may perform the reading process by reading a document with the scanner 307 and generating image data in a CMYK (Cyan, Magenta, Yellow, Black) format suitable for copying.

In Step S813, the reading part 423 transmits a reading completion notice (i.e., notice indicating the completion of the reading process) to the copy control part 422 when the reading process is finished.

In Step S814, the copy control part 422 that has received the reading completion notice transmits a printing request to the printing part 424 for requesting the printing part 424 to print the image data generated by the reading part 423.

In Step S815, the printing part 424 executes a printing process for printing the image data generated by the reading part 423.

In Step S816, the printing part 424 reports the completion of the printing process (printing completion report) to the copy control part 422 when the printing process is completed.

Note that the processes in Step S806, S812 to S816 are repeated in a case of printing multiple pages or printing multiple copies.

According to the above-described processes, the image forming apparatus 110 can display the operation screen of the copying process on the operation part 306 by using the web contents obtained from the server apparatus 120. Further, the copying process can be executed as an internal process inside the image forming apparatus 120 by operating on the operation part 306.

### <Canceling the Copying Process>

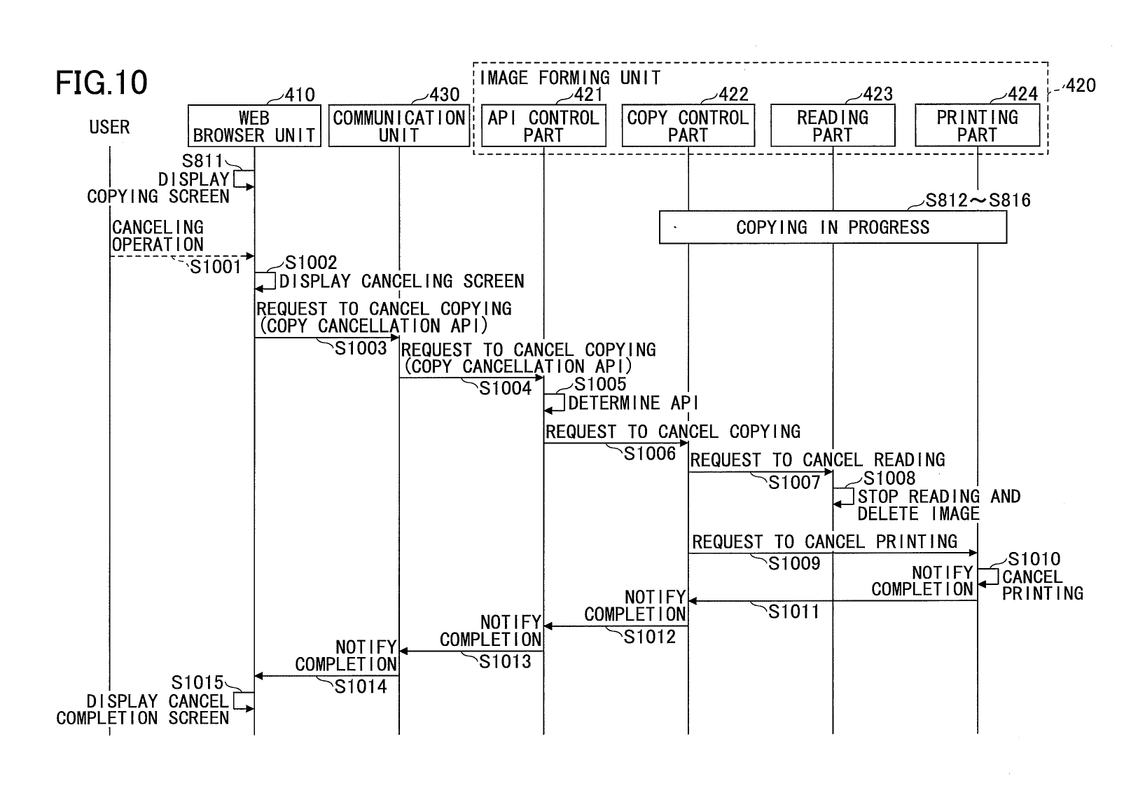

FIG. 10 is a sequence diagram illustrating an example of a copy canceling process according to the first embodiment of the present invention. Note that the processes in Step S811 and Step S812 are substantially the same as the processes illustrated in FIG. 10. Next, a process of canceling a copying process being performed during Step S812 to S816 is explained.

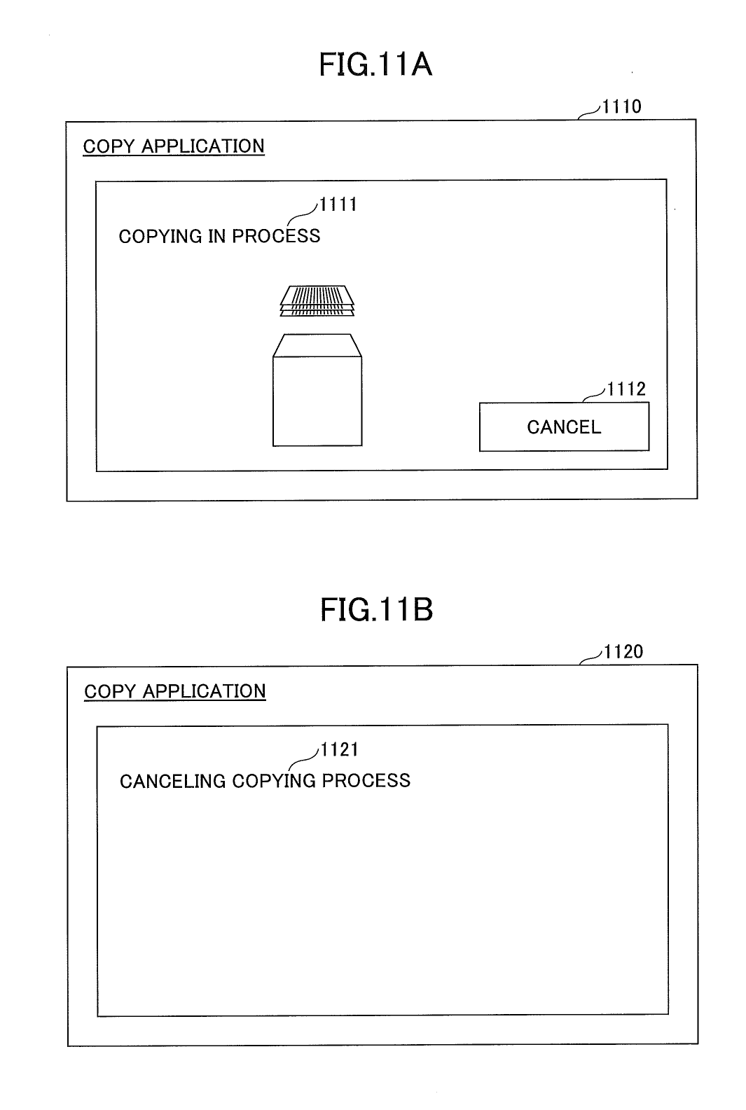

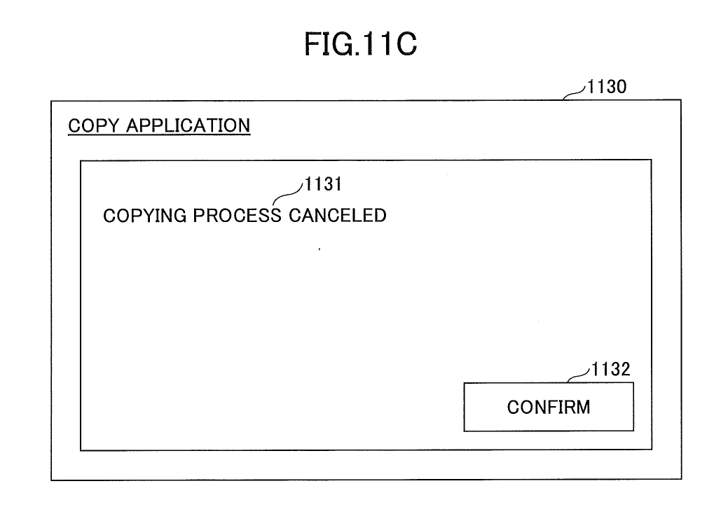

In Step S1001 of FIG. 10, the user performs a process of canceling a copying process that is being performed. In the case where the copying process is being performed, a copying display screen (i.e., screen that is displayed when the copying process is being performed) 1110 as illustrated in FIG. 11A is displayed on the operation part 306 of the image forming apparatus 110 in Step S811 of FIG. 10. The copying display screen 1110 includes, for example, a message 1111 indicating that the copying process is being performed and a cancel button 1112 for canceling the copying process being performed. Accordingly, the user can cancel a copying process being performed by selecting the cancel button 1112 displayed on the copying display screen 1110.

In Step S1002 of FIG. 10, the display control part 414 displays a canceling screen (i.e., screen that is displayed when the copying process is being canceled) 1121 in a case where the operation reception part 415 of the web browser part 410 receives a cancelation operation. Accordingly, in Step S1003 of FIG. 10, the script execution part 413 of the web browser part 410 transmits a copy cancel request (copy cancellation API) to the image forming unit 420 via the communication part 430 for requesting that the copying process be cancelled. Similar to the copy API, the copy cancellation API transmitted by the script execution part 413 is an API having a format that is set beforehand.

When the image forming unit 420 receives the copy cancellation request, the API control part 421 determines whether the format of the copy cancellation request received from the script execution part is an API format that is set beforehand in Step S1005 of FIG. 10.

In a case where the format of the received copy cancellation request is determined to be a format of a copy cancellation API, the API control part 421 reports the copy cancellation request to the copy control part 422 in Step S1006.

In Step S1007, the copy control part 422 that received the copy cancellation request from the API control part 421 starts a copy cancellation process and, for example, transmits a reading cancellation request to the reading part 423 for instructing the reading part 423 to cancel the reading of a document.

When the reading part 423 receives the reading cancellation request, the reading part 423 stops reading the document and, for example, deletes image data read from the document in Step S1008.

In Step S1009, the copy control part 422 transmits a printing cancellation request to the printing part 424 for requesting the printing part 424 to stop a printing process.

When the printing part 424 receives the printing cancellation request, the printing part 424 stops the printing process being performed and, for example, reports the completion of canceling the printing process (copy cancellation completion report) to the copy control part 422.

In Step S1012 to Step S1014, the copy cancellation completion report is sequentially transmitted from the copy control part 422 web browser part 410.

In Step S1015, the display control part 414 of the web browser part 410 displays a cancel completion screen on the operation part 306 to indicate the completion of cancelling the copying process. FIG. 11C illustrates an example of the cancel completion screen displayed on the operation part 306.

In the example of FIG. 11C, a message 1131 indicating the cancellation of the copying process and a confirmation button 1132 are displayed in the cancel completion screen 1130. The user can return to the operation screen of the copying process illustrated in FIGS. 7A to 7C by selecting the confirmation button 1132.

According to the above-described processes, the image forming apparatus 110 can display an operation of a copying process on the operation part 306 by using web contents obtained from the server apparatus 120 and perform a copy cancellation process in the image forming apparatus 110 by operating on the operation part 306.

### Second Embodiment

As illustrated in FIG. 1, the functions usable for the image forming apparatus 110-1 of the image forming system 100 may be different from the functions usable for the image forming apparatus 110-2 (e.g., whether the image forming apparatus has a color printing function). The second embodiment is described as a case where the image forming apparatus 110 obtains web contents from the server apparatus 120 and uses the web contents to display an operation screen of a copying process according to the information pertaining to the functions usable for the image forming apparatus 110 (i.e., capability information).

In the second embodiment, like parts, units, and components are described with like reference numerals as those of the first embodiment and are not further described.

First, the user performs an operation of calling an operation screen of a copying process (Step S1201).

When the operation reception part 415 receives the user's operation, the obtaining part 411 of the web browser part 410 transmits a contents obtaining request to the server apparatus 120 via the communication part 430 for obtaining web contents (Step S1202).

When the server apparatus 120 receives the contents obtaining request from the image forming apparatus 110 (Step S1203), the web contents management part 452 reads out web contents from the web contents storage part 451 (Step S1204). Note that the process of Step S1204 corresponds to, for example, the processes performed in Steps S604 to S607 of FIG. 6.

Then, the web contents management part 452 of the server apparatus 120 transmits the read out web contents to the image forming apparatus 110 being the source of the contents obtaining request (Step S1205).

When the web browser part 410 receives the web contents from the server apparatus 120 (Step 1206), the display control part 414 displays the operation screen of the copying process on the operation part 306 based on the web contents (Step S1207). In displaying the operation screen of the copying process, the display control part 414 may display the operation screen of the copying process on the operation part 306 in a manner illustrated in FIG. 7A. Note that the processes performed in Steps S1201 to S1207 may be the same as the processes performed in the first embodiment.

Then, the script execution part 413 of the web browser part 410 transmits a device information request (device information request API) to the image forming unit 420 via the communication part 430 for obtaining functional configuration information (Step S1208). The function configuration information is information that includes information pertaining to functions usable for the image forming unit 420 (capability information).

The web contents of the second embodiment includes, for example, a script that transmits a device information request (device information request API) to the image forming unit 420 in a case such as displaying the operation screen of the copying process in Step S1207. Similar to the copy API, the device information request API transmitted by the script execution part 413 is an API having a format that is set beforehand.

Then, the image forming unit 420 receives the device information request (device information request API) from the web browser part 410 (Step S1209).

Then, the API control part 421 of the image forming unit 420 determines whether the device information request is the device information request API that is set beforehand and reads out device configuration information (Step S1210). For example, the API control part 421 transmits a request to obtain device information (device information obtaining request) to the copy control part 422.

Then, the copy control part 422 receiving the device information obtaining request reads out device configuration information stored in the device information storage part 425 and reports the device configuration information to the API control part 421.

Then, the API control part 421 of the image forming unit 420 transmits the read out device configuration information to the web browser part 410 via the communication part 430 (Step S1211).

Then, the web browser part 410 receives the device configuration information from the image forming unit 420 (Step S1212).

Then, the display control part 414 of the web browser part 410 updates the operation screen of the copying process displayed on the operation part 306 by using the received device configuration information (Step S1213).

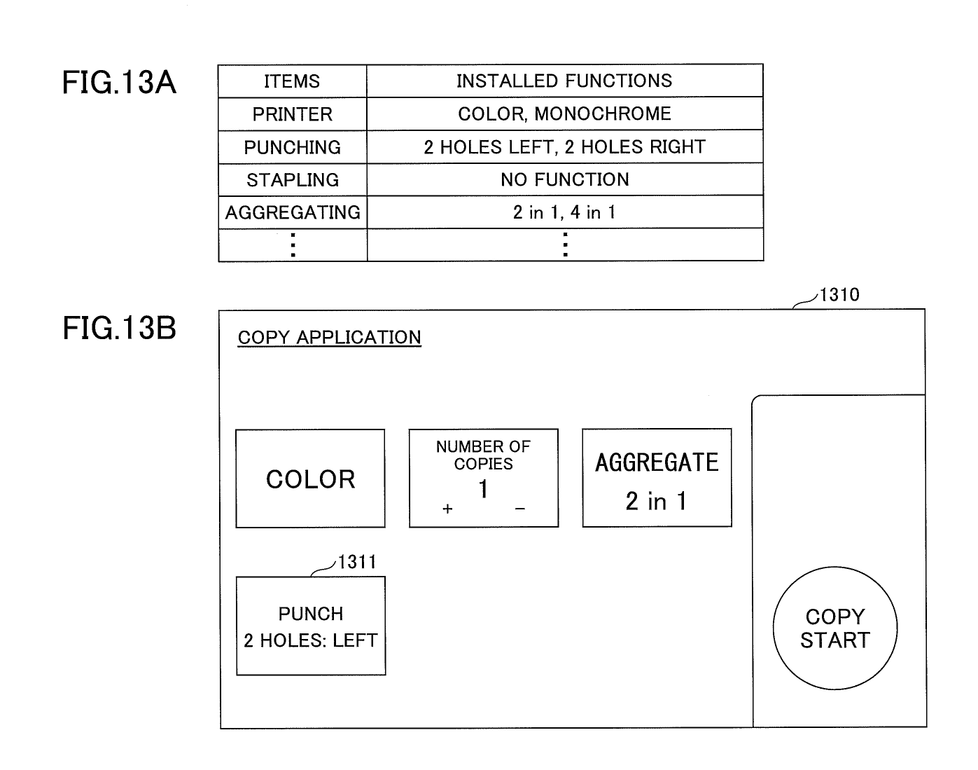

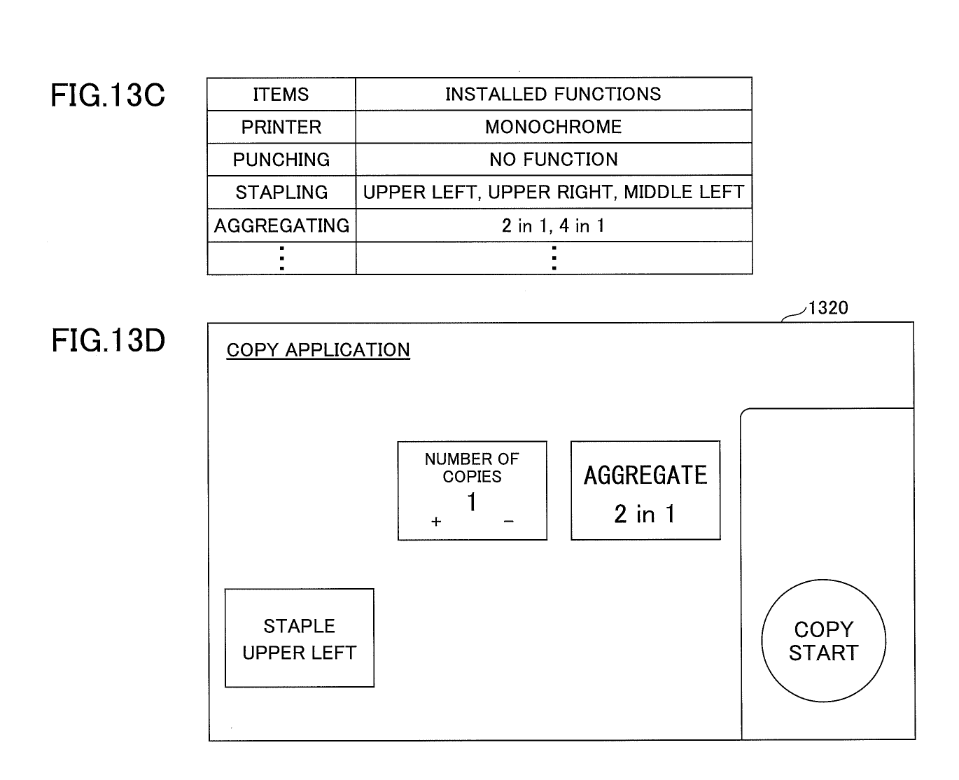

FIG. 13A illustrates an example of the device configuration information of the image forming apparatus 110. The device configuration information of FIG. 13A is, for example, the device configuration information of the image forming apparatus 110-1 of FIG. 1. The device configuration information of FIG. 13A indicates, for example, that the printer function of the image forming apparatus 110-1 is compatible with “color printing” and “monochrome printing” and that the punching function is compatible with “2 holes left” and “2 holes right”. Further, the device configuration information of the image forming apparatus 110-1 indicates that the image forming apparatus 110-1 is not compatible with the stapling function and that the aggregate function is compatible with “2 in 1” and “4 in 1”.

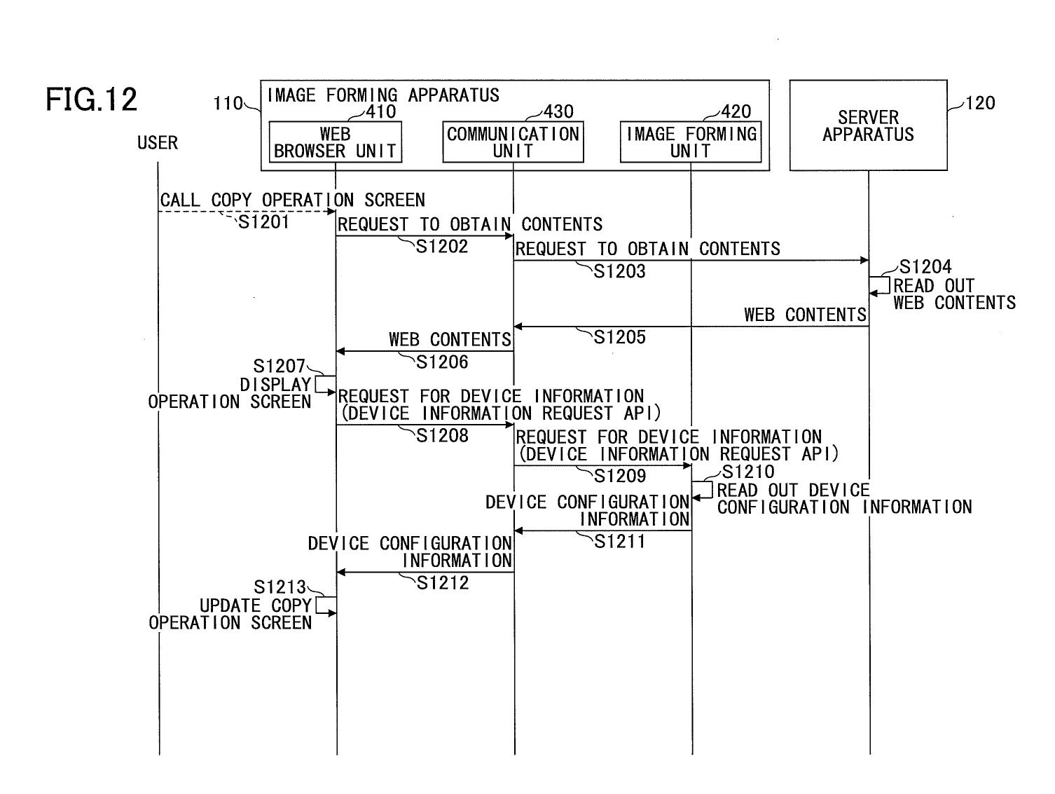

For example, in Step S1213 of FIG. 12, the display control part 414 updates the operation screen 710 of the copying process illustrated in FIG. 7A to the operation screen 1310 of the copying process illustrated in FIG. 13B.

In comparison with the operation screen 710 of FIG. 7A, the setting button 714 of the stapling function is omitted in the operation screen 1310 of FIG. 13B because the image forming apparatus 110-1 is not compatible with the stapling function. Further, in comparison with the operation screen 710 of FIG. 7A, the setting button 1311 of the punching function is added to the operation screen 1310 because the image forming apparatus 110-1 is compatible with the punching function.

Next, another example of the device configuration information of the image forming apparatus 110 is described with reference to FIG. 13C. The device configuration information of FIG. 13C is, for example, the device configuration information of the image forming apparatus 110-2 of FIG. 1. The device configuration information of FIG. 13C indicates, for example, that the printer function of the image forming apparatus 110-2 is compatible only with “monochrome printing” and that the image forming apparatus 110-2 is not compatible with the punching function. Further, the device configuration information of the image forming apparatus 110-2 indicates that the image forming apparatus 110-2 is compatible with the stapling functions “upper left”, “upper right”, and “middle left” and that the aggregate function is compatible with “2 in 1” and “4 in 1”.

Thus, in Step S1213 of FIG. 12, the display control part 414 updates the operation screen 710 of the copying process illustrated in FIG. 7A to the operation screen 1320 of the copying process illustrated in FIG. 13D.

In comparison with the operation screen 710 of FIG. 7A, the setting button 711 of the color printing function is omitted in the operation screen 1320 of FIG. 13D because the image forming apparatus 110-2 is not compatible with the color printing function.

Hence, the web browser part 410 of the image forming apparatus 110 of the second embodiment displays the operation screen of the copying process on the operation part 306 based on the web contents obtained from the server apparatus 120 and the device configuration information obtained from the image forming unit 420.

Accordingly, the image forming system 100 can use the same web contents and display the operation screen of the copying process corresponding to the functions usable for each of the image forming apparatuses 110 (110-1, 110-2) even in a case where the image forming apparatuses 110 (110-1, 110-2) have different usable functions.

### Third Embodiment

According to the third embodiment of the present invention, the script execution part 413 of the web browser part 410 obtains information indicating the process status of the copying process from the image forming unit 420, and the display control part 414 displays the operation screen on the operation part 306 according to the process status obtained by the script execution part 413.

In the third embodiment, like parts, units, and components are described with like reference numerals as those of the first embodiment and are not further described.

The user performs an operation for executing a copying process by selecting a copy start button 715 displayed on the operation screen of the copying process as illustrated in FIG. 7A-7C.

When the operation reception part 415 receives the user's operation, the script execution part 413 of the web browser part 410 transmits a copy execution request (copy API) to the image forming unit 420 via the communication part 430 for requesting the execution of the copying process (Step S1402).

The image forming unit 420 receives the copy execution request (copy API) transmitted from the web browser part 410 (Step S1403).

When the API control part 421 of the image forming unit 420 determines that the received copy execution request is a copy API (Step S1404), the API control part 421 transmits a response message in response to the copy API to the web browser part 410 via the communication part 430 (Step S1405).

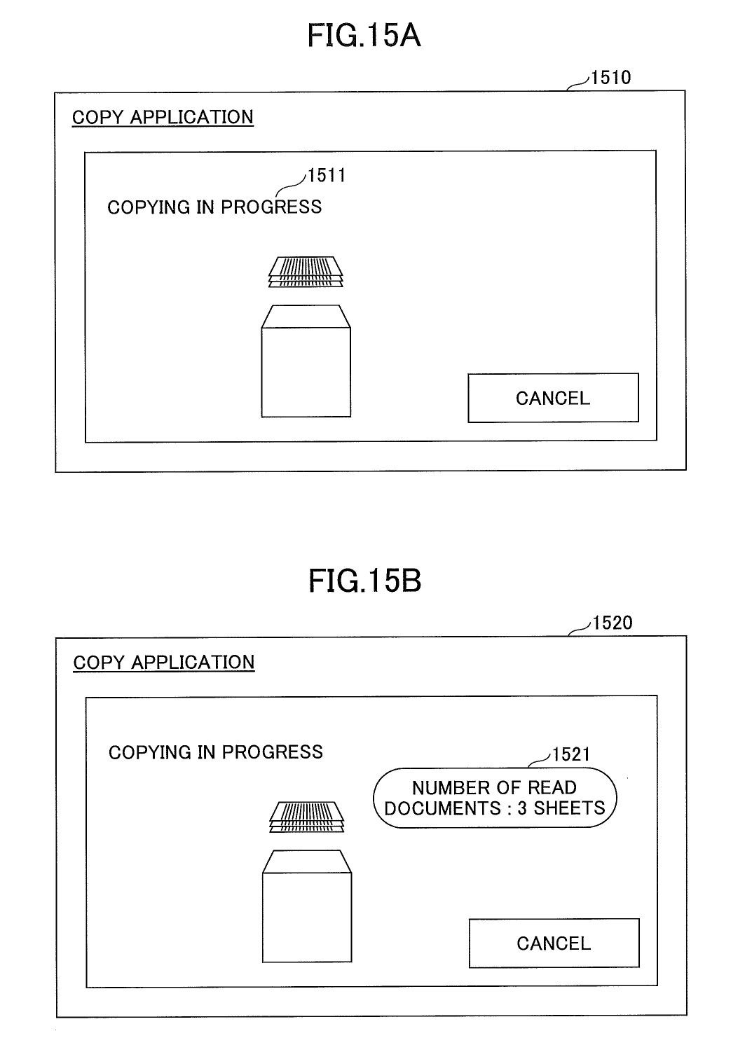

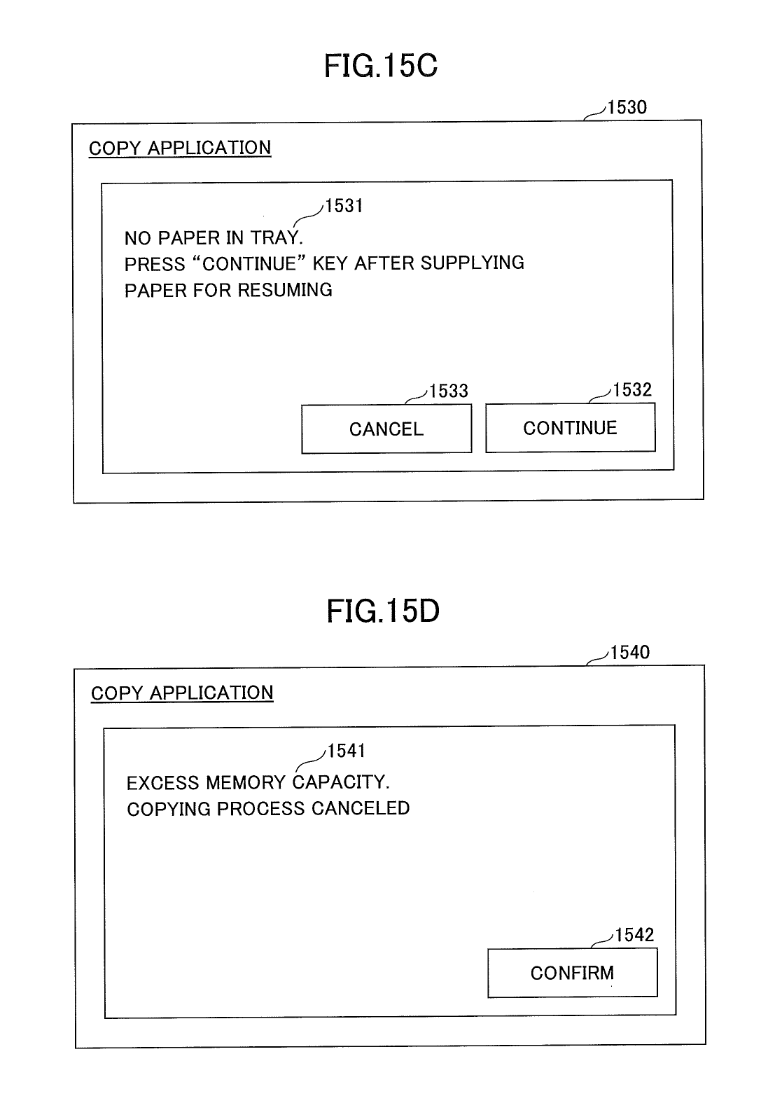

When the web browser part 410 receives the response message transmitted in response to the copy API, the display control part 414 displays a copying in-progress screen 1510 on the operation part 306 as illustrated in, for example, FIG. 15A (Step S1406). The copying in-progress screen 1510 includes a message 1511 indicating that the copying process is in progress.

The API control part 421 of the image forming unit 420 requests the execution of the copying process to the copy control part 422, and the reading part 423 executes a process of reading a document according to the controls of the copy control part 422 (Step S1407).

The script execution part 413 of the web browser part 410 transmits a status obtaining request (status obtaining API) to the image forming unit 420 via the communication part 430 for requesting information indicating the execution status of the copying process (Step S1408). The web contents of the third embodiment includes, for example, a script that transmits a status obtaining request to the image forming unit 420 at predetermined time periods or in correspondence with a predetermined process. Similar to the copy API, the status obtaining API transmitted by the script execution part 413 is an API having a format that is set beforehand.

The image forming unit 420 receives the status obtaining request (status obtaining API) from the web browser part 410 (Step S1409).

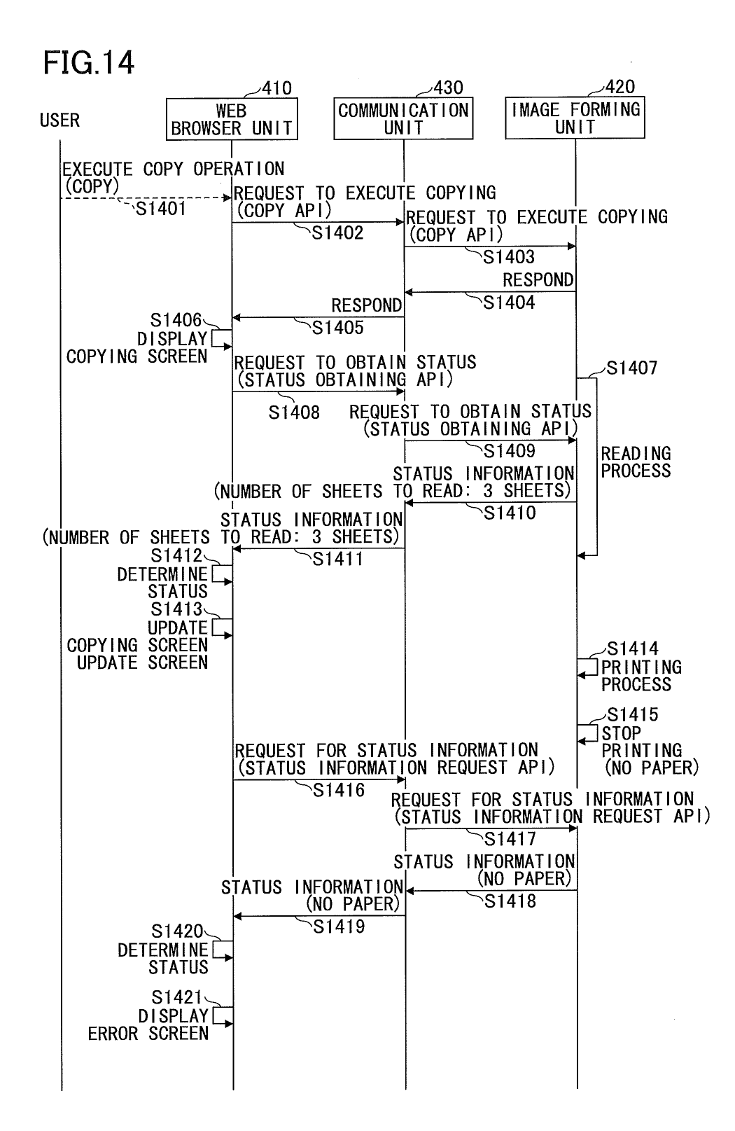

When the API control part 421 of the image forming unit 420 determines that the received status obtaining request is a status obtaining API, the API control part 421 transmits status information indicating the status of the copying process to the web browser part 410 via the communication part 430 (Step S1410). For example, when the API control part 421 receives the status obtaining API, the API control part 421 obtains status information indicating the status of the copying process from the copy control part 422 and transmits the obtained status information to the web browser part 410. In the example of FIG. 14, the process status of the copying process is “copying in progress” in which the third sheet is being read.

The web browser part 410 receives the status information transmitted from the image forming unit 420 (Step S1411).

The script execution part 413 of the web browser part 410 determines the process status of the copying process by using the status information received from the image forming unit 420 (Step S1412).

In the example of FIG. 14, the script execution part 413 determines that the process status of the copying process is “copying in progress” in which the third sheet is being read.

The display control part 414 of the web browser part 410 displays a copy in-progress screen 1520 (see, for example, FIG. 15B) on the operation part 306 according to the process status of the copying process determined in Step S1412 (Step S1413). In addition to the data displayed in the display screen of FIG. 15A, the copying in-progress screen of FIG. 15B also includes, for example, information 1521 indicating the number of documents that have been read.

When the document reading process is completed, the copy control part 422 of the image forming unit 420 starts the process of printing the image data read from the document (S1414). In the example of FIG. 14, the printing process is stopped due to no paper (Step S1415).

The script execution part 413 of the web browser part 410 re-transmits a status obtaining request (status obtaining API) to the image forming unit 420 via the communication part 430 for requesting information indicating the execution status of the copying process (Step S1416).

Then, the image forming unit 420 receives the status obtaining request (status obtaining API) transmitted from the web browser unit (Step S1417).

Then, when the API control part 421 of the image forming unit 420 determines that the received status obtaining request is the status obtaining API, the API control part 421 transmits the status information indicating the status of the copying process to the web browser part 410 via the communication part 430 (Step S1418). In the example of FIG. 14, the API control part 421 transmits status information indicating that the printing process is stopped due to lack of paper.

Then, the web browser part 410 receives the status information transmitted from the image forming unit 420 (Step S1419).

Then, the script execution part 413 of the web browser part 410 determines the status of the copying process by using the received status information (Step S1420). In the example of FIG. 14, the script execution part 413 determines that the status of the copying process is “stop of printing” due to lack of paper.

The display control part 414 of the web browser part 410 displays a copying in-progress screen 1530 on the operation part 306 as illustrated in, for example, FIG. 15C according to the status of the copying process determined in Step S1412 (Step S1421).

The copying in-progress screen 1530 of FIG. 15c displays, for example, a message 1531 indicating “no paper in the tray”, a “continue” button 1532 for resuming the printing process, and a “cancel” button 1533 for canceling the printing process. In this case, the user can resume the printing process by resupplying paper to the image forming apparatus 110 and selecting the “continue” button 1532.

Alternatively, in a case where the image forming apparatus 110 cannot continue the printing process due to, for example, shortage of memory, the display control part 414 of the web browser part 410 displays a copy execution in-progress screen 1540 on the operation part 306 as illustrated in FIG. 15D.

The copying in-progress screen 1540 of FIG. 15D displays a message 1541 indicating the cancellation of the copying process due to excess memory space of the system and a “confirmation” button 152. Accordingly, the image forming apparatus 110 can report to the user that the printing process cannot be continued.

### Fourth Embodiment

According to the fourth embodiment of the present invention, the user performs a process of reading a document by using a pressure plate of the image forming apparatus 110 when performing the copying process. Note that the pressure plate is an openable/closable unit for holding (exerting pressure to) the document provided on the glass surface of the scanner 307 for reading the document.

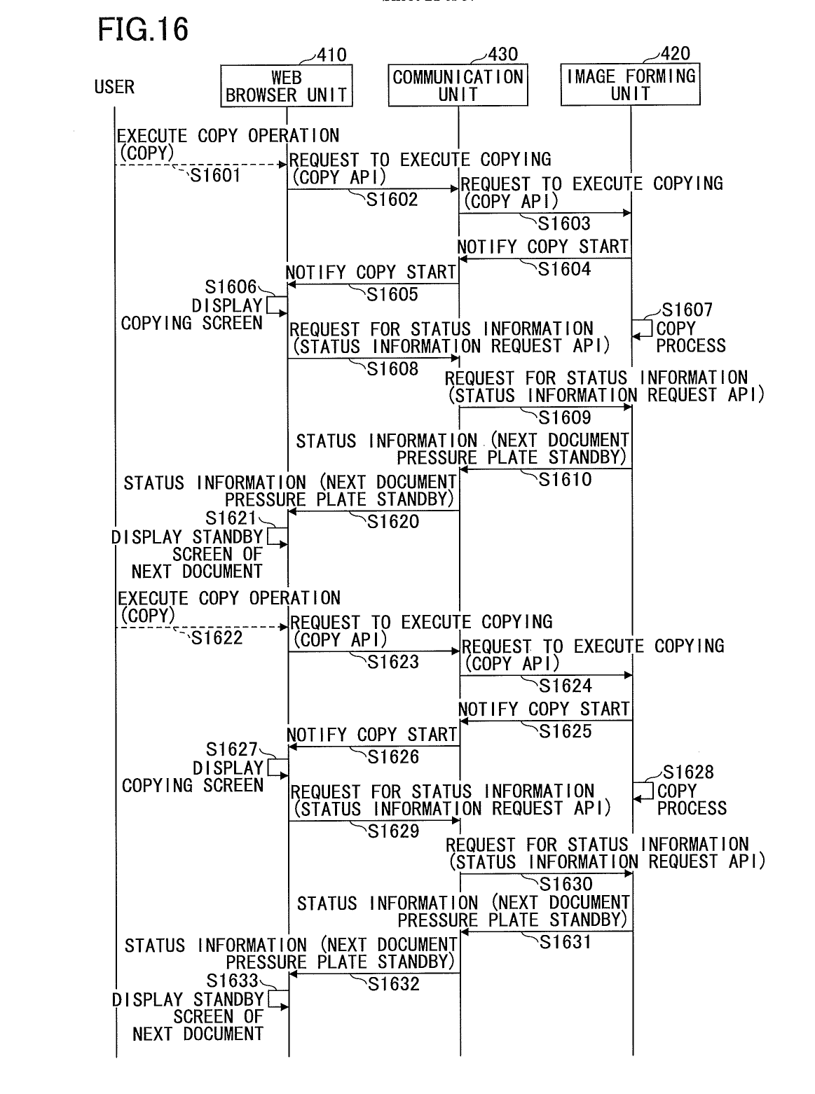

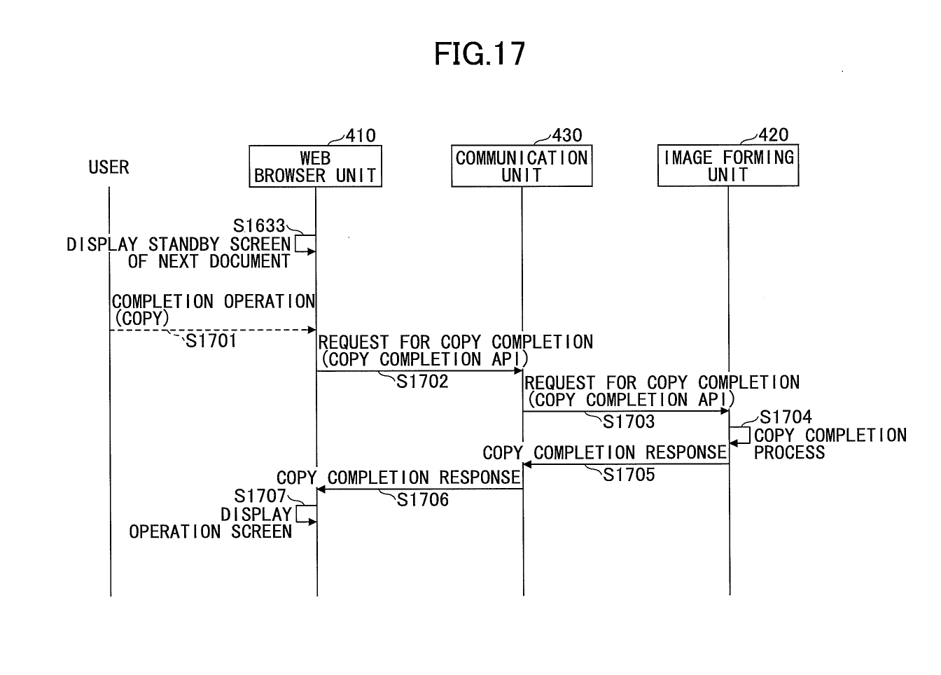

FIGS. 16 and 17 are schematic diagrams illustrating a copying process according to the fourth embodiment of the present invention.

First, the user performs an operation for executing the copying process by, for example, setting the first page of a document placed on the glass plane of the scanner 307, closing the pressure plate, and selecting the “copy start” button (step S1601).

When the operation reception part 415 receives the user's operation, the script execution part 413 of the web browser part 410 transmits a copy execution request to the image forming unit 420 via the communication part 430 for requesting the execution of the copying process (Step S1602).

Then, the image forming unit 420 receives the copy execution request (copy API) transmitted from the web browser part 410 (Step S1603).

When the API control part 421 of the image forming unit 420 determines that the received copy execution request is a copy API, the API control part 421 transmits a copy start notice to the web browser part 410 via the communication part 430 for notifying that the copying process has started (S1604).

Then, the web browser part 410 receives the copy start notice transmitted from the image forming unit 420 (Step S1605).

When the web browser part 410 receives the copy start notice, the display control part 414 of the web browser part 410 displays the copying in-progress screen 1510 on the operation part 306 as illustrated in, for example, FIG. 15A (Step S1606).

Then, the API control part 421 of the image forming unit 420 requests the execution of the copying process to the copy control part 422, and the copy control part 422 executes the copying process (reading process and printing process) of the first page of the document (Step S1607).

Then, the script execution part 413 of the web browser part 410 transmits a status obtaining request (status obtaining API) to the image forming unit 420 via the communication part 430 for requesting information indicating the status of the copying process (Step S1608). The web contents of the fourth embodiment includes, for example, a script that transmits a status obtaining request to the image forming unit 420 at predetermined time periods or in correspondence with a predetermined process.

Then, the image forming unit 420 receives the status obtaining request (status obtaining API) transmitted from the web browser part 410 (Step S1609).

When the API control part 421 of the image forming unit 420 determines that the received status obtaining request is a status obtaining API, the API control part 421 transmits the status information indicating the status of the copying process to the web browser part 410 via the communication part 430 (Step S1610). In this case of transmitting the status information, the status information indicates, for example, that a copying process using the pressure plate is in progress and that the next document is standing by to be set (next document pressure plate standby state).

Then, the web browser part 410 receives the status information transmitted from the image forming unit 420 (Step S1611).

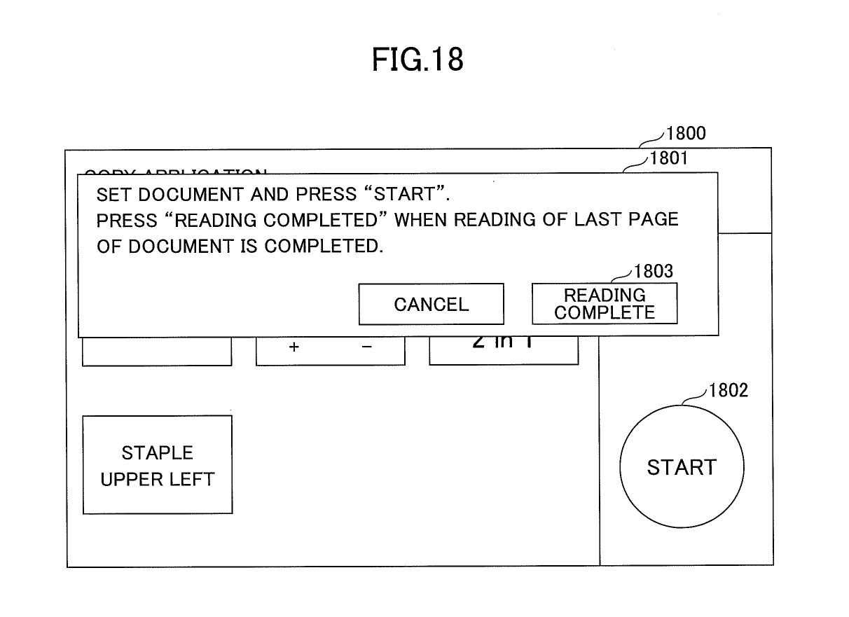

Then, the display control part displays the standby state 1800 of the next document on the operation part 306 as illustrated in, for example, FIG. 18 based on the received status information (Step S1621).

FIG. 18 is a schematic diagram illustrating an example of a standby screen of a next document according to the fourth embodiment of the present invention. The standby screen 1800 of the next document displays, for example, a message 1801 indicating that the status of the copying process is the “pressure plate next document standby” state, a start button 1802, and a reading complete button 1803 for finishing the reading (copying) process.

The user performs a copy execution operation by setting, for example, a document of the second page on the glass surface of the scanner 307, closing the pressure plate, and selecting the start button 1802 (Step S1622).

In Steps S1623 to S1632, the same processes as those performed in Steps S1602 to S1620 are performed. Then, the standby screen 1800 of the next document is displayed again on the operation part 306 (Step S1633).

By repeating the processes illustrated in FIG. 16, the user can copy an arbitrary number of documents. Further, in a case of completing the copying process (e.g., a case where all of the documents are read), a copy completion process is executed as illustrated in, for example, FIG. 17.

In Step S1633 of FIG. 17, it is assumed that the standby screen of the next document is displayed on the operation part 306 as illustrated in, for example, FIG. 18.

The user performs the copy completion operation by selecting the reading complete button 1803 displayed on the standby screen 1800 of the next document as illustrated in, for example, FIG. 18 (Step S1701).

When the operation reception part 415 receives the user's operation, the script execution part 413 of the web browser part 410 transmits a copy completion request (copy completion API) to the image forming unit 420 via the communication part 430 for requesting the completion of the copying process (Step S1702). Similar to the copy API, the copy completion API is an API having a format that is set beforehand.

Then, the image forming unit 420 receives the copy completion request (copy completion API) transmitted from the web browser part 410 (Step S1703).

When the API control part 421 of the image forming unit 420 determines that the received copy completion request is a copy completion API, the API control part 421 performs a copying completion process (Step S1704). The copy completion process includes, for example, a process of releasing the “pressure plate next document standby” state and a process of printing image data that is already read but not yet printed.

Then, the API control part 421 of the image forming unit 420 transmits a message in response to the received copy completion API (copy completion response) to the web browser part 410 via the communication part 430 (Step S1705).

Then, the web browser part 410 receives the copy completion response transmitted from the image forming unit 420 (Step S1706).

Then, the display control part 414 of the web browser part 410 displays the operation screen of the copying process on the operation part 306 as illustrated in, for example, FIG. 7A-7C (Step S1707).

Hence, the display control part 414 of the web browser part 410 according to the fourth embodiment can obtain information indicating the status of the copying process from the image forming part when the copying process is in progress and display the standby screen of the next document on the operation part 306 according to the obtained status of the copying process.

### Fifth Embodiment

The script for controlling the copying process executed by the script execution part 413 of the web browser part 410 of the image forming apparatus 110 may include a script for setting (changing) the setting information pertaining to the copying process or the like (e.g., initial setting information). According to the fifth embodiment of the present invention, the web browser part 410 allows the initial setting information of the image forming unit 420 to be set with the operation screen of the copying process displayed on the operation part 306.

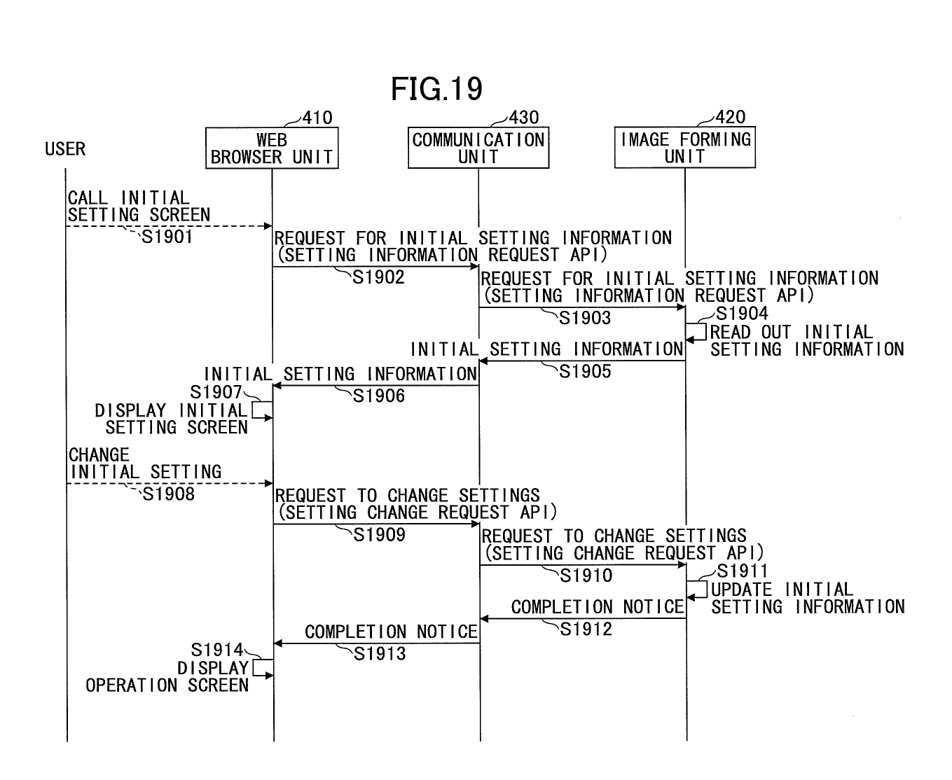

FIG. 19 is a sequence diagram illustrating an example of an initial setting process according to the fifth embodiment of the present invention.

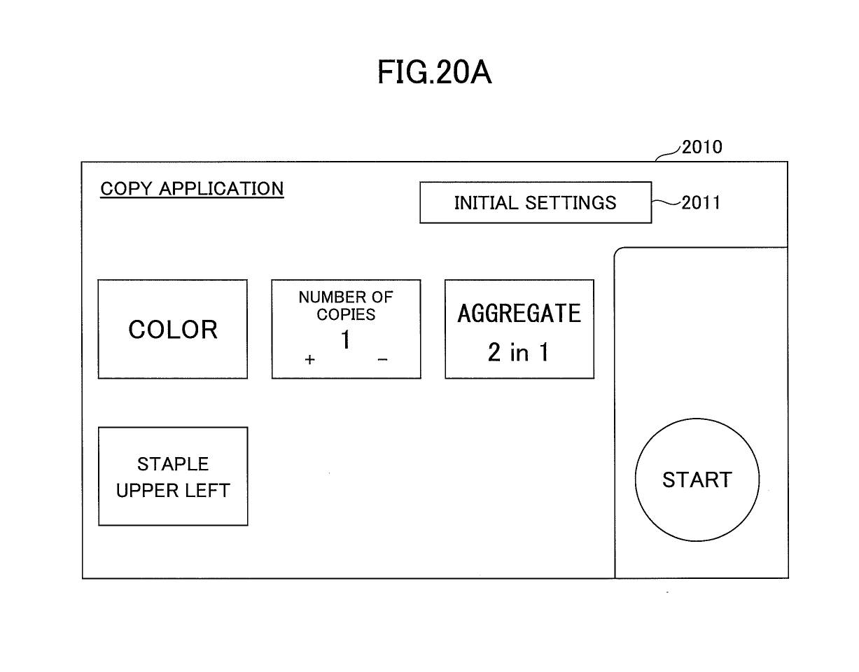

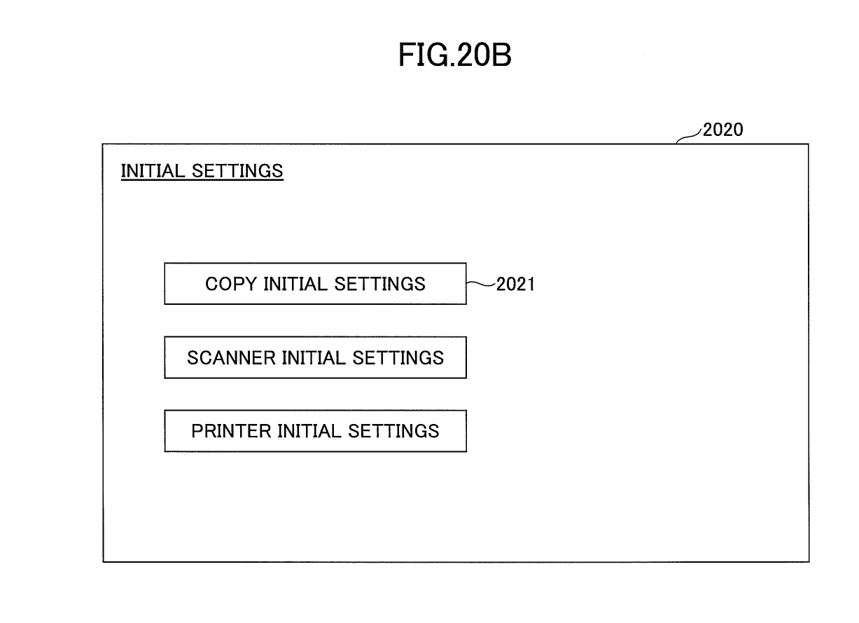

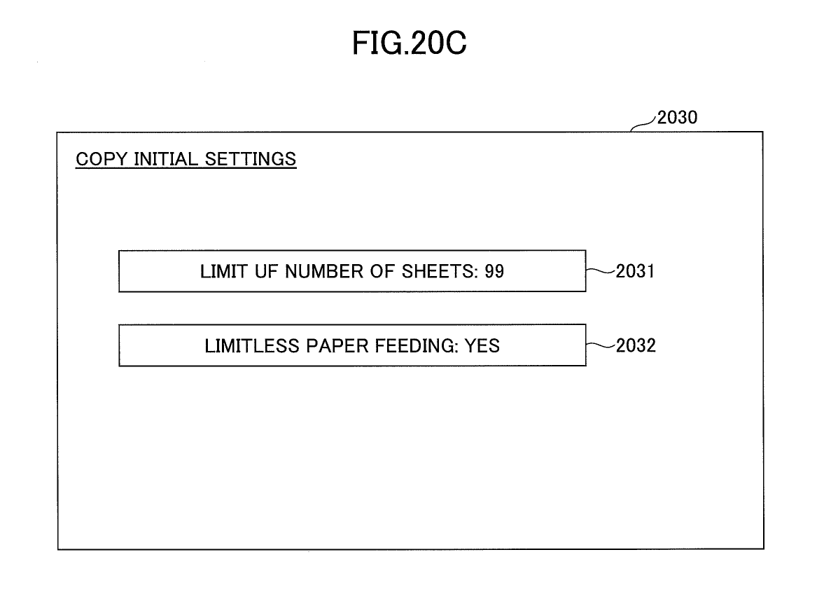

First, the user performs an operation of calling the initial setting screen (Step S1901). For example, the web browser part 410 displays a setting screen 2010 of the copying process on the operation part 306 as illustrated in FIG. 20A. The user performs the operation of calling the initial setting screen by selecting the initial setting button displayed on the setting screen 2010 of the copying process.

According to another example of the fifth embodiment, an initial setting screen 2020 illustrated in FIG. 20B may be displayed on the operation part 306 when the initial setting button displayed in the setting screen is selected. In this example, the user can perform the operation of calling the initial setting screen of the copying process by selecting the copy initial setting button 2021 displayed on the initial setting screen 2020.

When the operation reception part 415 receives the user's operation, the script execution part 413 of the web browser part 410 transmits an initial setting request (initial setting API) to the image forming unit 420 via the communication part 430 for requesting that the setting, information be obtained (Step S1902). Similar to the copy API, the setting information request API) is an API having a format that is set beforehand.

Then, the image forming unit 420 receives the initial setting information request (setting information request API) transmitted from the web browser part 410 (Step S1903).

When the API control part 421 of the image forming unit 420 determines that the received initial setting information request is the setting information request API determined beforehand, the API control part 421 reads out initial setting information. For example, the API control part 421 transmits the initial setting information obtaining request to the copy control part 422, and the copy control part 422 receiving the request reads out the initial setting information stored in the setting information storage part 426 and reports (notifies) the initial setting information to the API control part 421. Note that the initial setting information is an example of setting information pertaining to the copying process of the image forming unit 420. The initial setting information may include, for example, information indicating whether to limit the number of sheets to be copied with the image forming unit 420, the limit of the number of sheets (in a case of limiting the number of sheets to be copied), and the setting information that are common among multiple copying processes.

Then, the API control part 421 of the image forming unit 420 transmits the read out initial setting information to the web browser part 410 via the communication part 430 (Step S1905).

Then, the web browser part 410 receives the initial setting information transmitted from the image forming unit 420 (Step S1906).

Then, the display control part 414 of the web browser part 410 displays the initial setting screen 2020 of the copying process on the operation part 306 as illustrated in, for example, FIG. 20C (Step S1907).

The initial setting screen 2030 illustrated in FIG. 20C may include, for example, a button 2031 for setting the “limit of the number of sheets” and a button 2032 for setting to “limitless sheet feeding”. Note that the setting items “limit of the number of sheets” and “limitless sheet feeding” are merely examples, and other items may also be displayed in the initial setting screen 2030.

The user performs an operation of changing the initial settings by selecting, for example, the button 2031 for setting the “limit of the number of sheets” or the button 2032 for setting “limitless sheet feeding” displayed in the initial setting screen 2030 of FIG. 20C (Step S1908).

When the operation reception part 415 receives the user's operation, the script execution part 413 of the web browser part 410 transmits a setting change request (setting change request API) to the image forming unit 420 via the communication part 430 for requesting the setting information to be changed (Step S1909). Similar to the copy API, the setting change request API is an API having a format that is set beforehand.

Then, the image forming unit 420 receives the setting change request (setting change request API) transmitted from the web browser part 410 (Step S1910).

When the API control part 421 of the image forming unit 420 determines that the received initial setting information request is the setting change request API that is set beforehand, the API control part 421 updates the initial setting information (Step S1911). For example, the API control part 421 transmits a request for changing the initial setting information to the copy control part 422, and the copy control part 422 receiving the request updates the initial setting information stored in the setting information storage part 426.

Then, the API control part 421 of the image forming unit 420 transmits a completion notice (i.e., notice indicating the completion of updating the initial setting information) to the web browser part 410 via the communication part 430 (Step S1912).

Then, the web browser part 410 receives the completion notice transmitted from the image forming unit 420 (Step S1913).

Then, the display control part 414 of the web browser part 410 displays the operation screen of the copying process on the operation part 306 as illustrated in, for example, FIG. 20A (Step S1914).

Hence, the web browser part of the image forming apparatus 110 of the fifth embodiment can obtain the initial setting values of the copying process from the image forming unit 420 and display the initial setting screen on the operation part 306 for changing the initial setting values.

### <Web Contents>

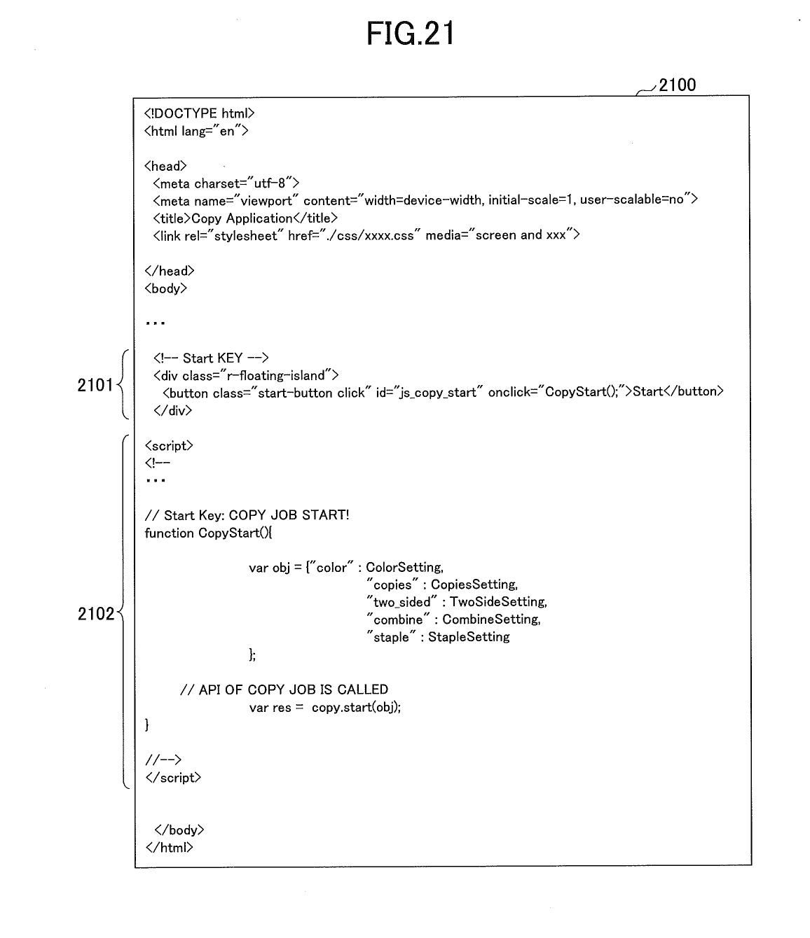

FIG. 21 is a schematic diagram illustrating an example of an image of web contents according to an embodiment of the present invention. Among the various web contents 2100 provided by the server apparatus 120, the example of FIG. 21 illustrates the information 2101 for displaying the start key (e.g., copy start screen of FIG. 5) and the script 2102 for executing the selected start key.

The information 2101 for displaying the start key is an example of the information pertaining to the operation screen of the copying process included in the web contents 2100. For example, information pertaining to the operation screen of the copying process may include the display position of the start button 505 or the method for displaying the operation screen of FIG. 5. Note that the information 2101 for displaying the start key is merely an example of the web contents 2100. The web contents 2100 may also include information for displaying various buttons on the operation screen.

The script 2102 that is executed when the start key is selected is an example of a script for controlling the copying process. In the example illustrated in FIG. 21, an API for requesting the execution of the copying process (copy API) is called when the start key is selected. The web contents 2100 also include various scripts for controlling the copying process (e.g., Java script).

Although the web contents 2100 include the script 2102 for controlling the copying process (first script) in the example illustrated in FIG. 21, the script 2102 is merely an example of the information of the script for controlling the copying process. For example, reference information (e.g., URL of a link destination) of a script for controlling the copying process (second script) may be included as an alternative of (or in addition to) the first script 2102.

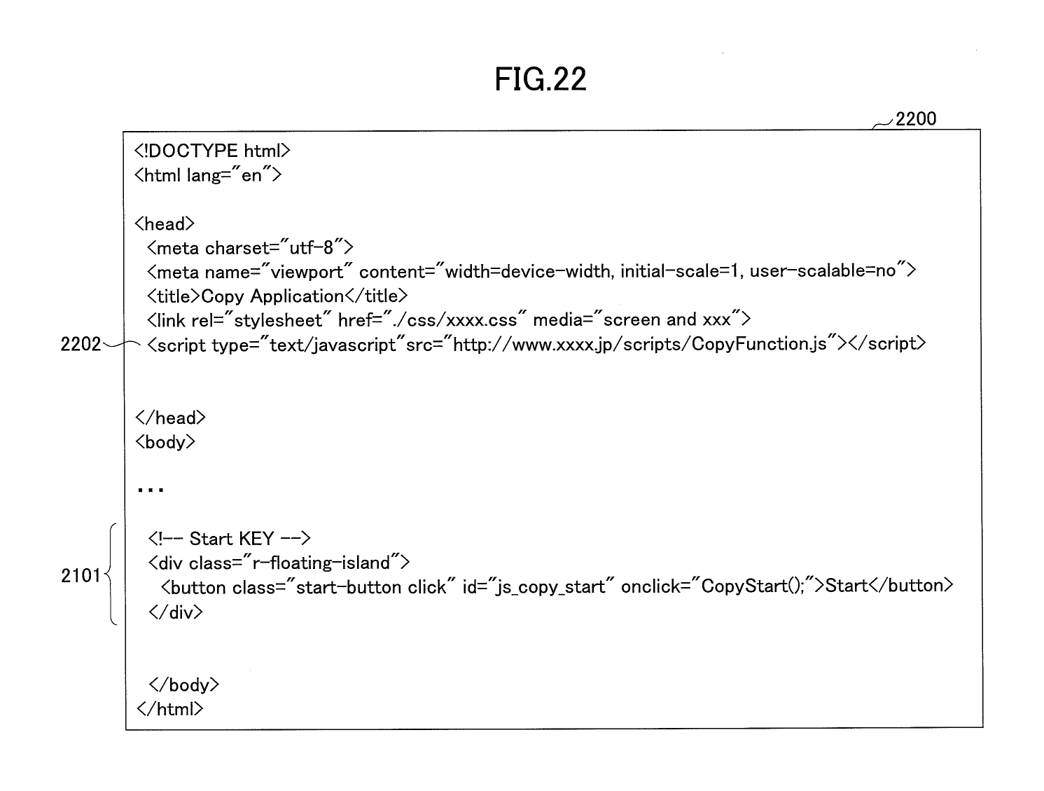

FIG. 22 is a schematic diagram illustrating another example of an image of web contents according to an embodiment of the present invention. Similar to the example of FIG. 21, the example of FIG. 22 also illustrates information 2101 for displaying the start key included in the web contents provided by the server apparatus 120.

Further, reference information 2202 indicating the location for obtaining the script for controlling the copying process is included in the header portion “head” of the web contents 2200. In the example of FIG. 22, the reference information 2202 indicates “CopyFunction. js” as the location for obtaining the script for controlling the copying process. In the example of FIG. 22, the script for controlling the copying process (e.g., CopyStart of FIG. 21) is formed with javascript® and is written in the location “CopyFunction.js”.

When the reference information 2202 is included in the header portion of the obtained web contents, the web browser part 410 obtains the script according to the reference information 2202 and loads the script. Accordingly, in the example of FIG. 22, a script “CopyStart( )” can be called by an “onclick” event included in the information 2101 for displaying the start key.

As described above, information pertaining to the operation screen of the copying process and information pertaining to a script for controlling the copying process are included in the web contents. Further, the information pertaining to the script for controlling the copying process includes at least one of a script 2102 for controlling the copying process (first script) and reference information 2202 of a script (second script) for controlling the copying process. Note that the web contents 2100, 2200 illustrated in FIGS. 21 and 22 are examples of the web contents.

### Sixth Embodiment

In the above-described first to fifth embodiments, the web browser part 410 is included in the image forming apparatus 110. Alternatively, the web browser part 410 may be included in an information terminal that can communicate with the image forming apparatus 110 as described in the following sixth embodiment.

In the sixth embodiment, the user of the image forming apparatus 110 uses an information terminal 140 to display an operation screen on the information terminal 140 and operate the image forming apparatus 110 with the operation screen displayed on the information terminal 140.

### <Functional Configuration>

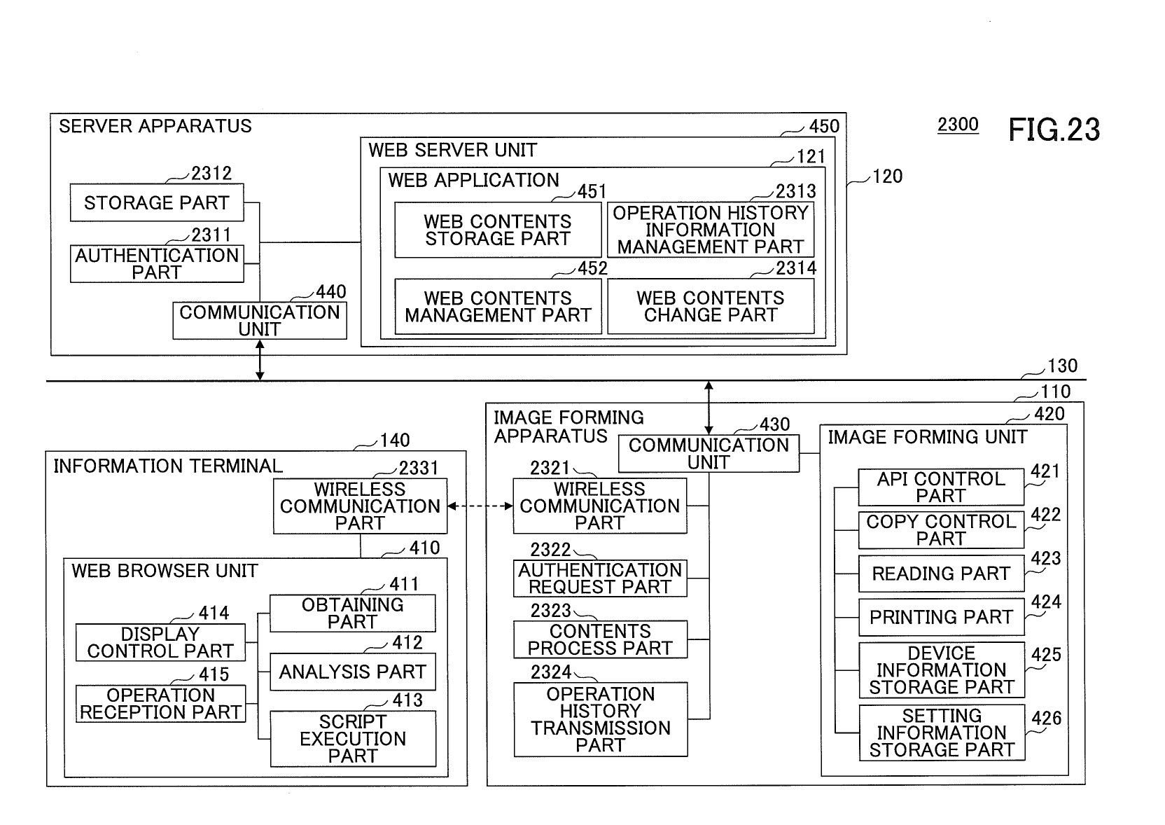

FIG. 23 is a schematic diagram illustrating a functional configuration of the image forming system 2300 according to an embodiment of the present invention. As illustrated in FIG. 23, the image forming system 2300 includes the server apparatus 120, and the image forming apparatus 110 connected to the server 120 via the network 130, and the information terminal 140 that can communicate with the image forming apparatus 110.

Note that the number of the image forming apparatuses 110 is not limited to the number of the image forming apparatuses 110 illustrated in FIG. 23. For example, one or more image forming apparatuses 110 may be set in various facilities such as an office, a school, or a hospital.

### <Functional Configuration of Server Apparatus>

The server apparatus 120 of the sixth embodiment includes an authentication part 2311 and a storage part 2312 in addition to the functional configuration of the server apparatus 120 illustrated in FIG. 4. The web application 121 that is executed by the web server unit 450 of the server apparatus 120 includes an operation history information management part 2313 and a web contents change part 2314 in addition to the functional configuration of the web application 121 illustrated in FIG. 4. Other parts of the configuration of the server apparatus 129 are substantially the same as those of the configuration of the server apparatus 120 illustrated in FIG. 4. Therefore, the differences between the server apparatus 120 of the sixth embodiment and the server apparatus 120 illustrated in FIG. 4 are mainly described below.

The authentication part 2311 performs authentication of the user of the image forming apparatus 110 according to a request from the image forming apparatus 110. The authentication part 2311 is implemented by, for example, a program executed by the CPU 201 of FIG. 2. For example, authentication information of a user authorized to use the image forming system 230 the authentication part 2311 is stored beforehand in the storage part 2312 of the server apparatus 120. Accordingly, the authentication part 2311 authenticates the user based on the authentication information stored in the storage part 2312.

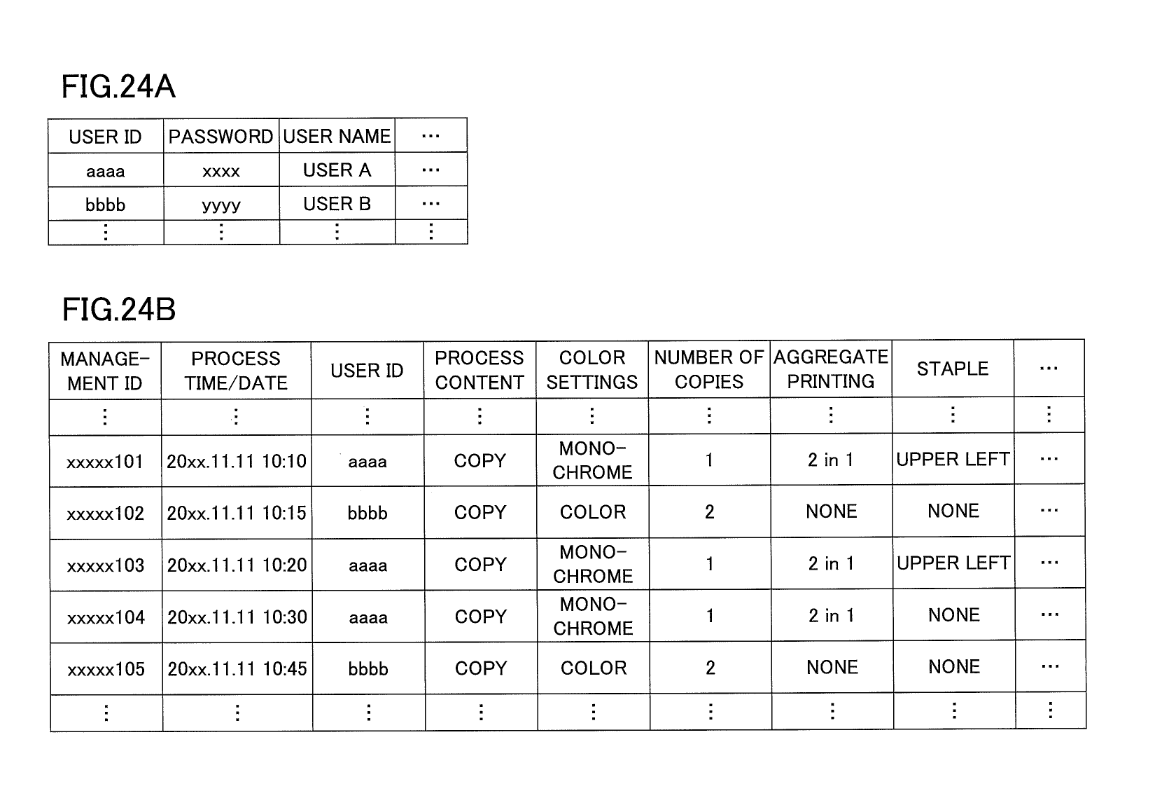

FIG. 24A illustrates an example of the authentication information stored beforehand in the storage part 2312 by the authentication part 2311. In the example of FIG. 24A, information such as “user ID”, “password”, and “user name” are included in the authentication information.

The item “user ID” is identification information for identifying the user. The item “password” is a password corresponding to the user ID. The password is an example of authentication information of the user. The authentication information of the user may also be, for example, a card ID stored in an IC card (e.g., employee ID card), biometric characteristic information used for biometric authentication (e.g., fingerprint authentication), or certification information stored in the user's information terminal 140. The item “user name” is information indicating the name of the user.

For example, in a case where the authentication part 2311 receives the user's authentication information including a combination of a user ID and a password from the image forming apparatus 110, the authentication part 2311 approves authentication of the user when the combination of the user ID and the password are included in the authentication information stored in the storage part 2312.

The storage part 2312 is a storage unit that stores various information. For example, the storage part 2312 is implemented by the storage unit 204 of FIG. 2 and a program executed by the CPU 201 of FIG. 2.

The operation history information management part 2313 added to the web application 121 receives an operation history indicating the history of the image forming processes of the user from the image forming apparatus 110. Further, the operation history information management part 2313 stores the received operation history as operation history information in the storage part 2312 and manages the operation history information.

FIG. 24B illustrates an example of the operation history information managed by the operation history information management part 2313. Information such as “management ID”, “process time/date”, “user ID”, “process content”, “color settings”, “number of copies”, “aggregate printing”, and “staple settings” are included in the operation history information.

The item “management ID” is identification information (e.g., serial number) for managing the operation history. The item “process time/date” is information indicating the time and date of performing a copying process or the like or the time and date of storing the history information. The item “user ID” is identification information for identifying the user. The item “user ID” corresponds to the user ID included in the authentication information of FIG. 24A.

The item “process content” is information indicating the type of process executed by the image forming apparatus 110 in accordance with the user's instruction. In this embodiment, the process content is described as a copying process. However, the process content stored in the operation history information may also include other processes such as printing or scanning.

The items “color settings”, “number of copies”, “aggregate printing”, and “staple settings” are examples of information indicating the settings of the copying process. For example, the operation history corresponding to management ID “xxxxx101” indicates that the user of user ID “aaaa” had executed the copying process under the conditions (settings) in which the color settings is “monochrome”, the number of copies is “1”, the aggregate printing is “2 in 1”, and the staple setting is “upper left”.

Accordingly, the operation history information managed by the operation history management part 2313 has the user's user ID (user identification information) stored in association with the history of the user's copying process.

The web contents change part 2314 added to the web application 452 changes the web contents provided from the web contents management part 452 to the image forming apparatus 110. The web contents change part 2314 changes the web contents by using the user's user ID and the operation history information managed by the operation history information management part 2313.

Thus, according to the operation history information illustrated in FIG. 24B, it can be determined that the user having the user ID “aaaa” frequently executes the copying process under the settings in which the color setting is “monochrome”. Therefore, in a case where the authentication of the user having the user ID “aaaa” is permitted, the web contents change part 2314 changes the web contents, so that the initial setting value of the color setting button included in the operation screen of the copying process is changed to “monochrome”.

Similarly, according to the operation history information illustrated in FIG. 24B, it can be determined that the user having the user ID “bbbb” frequently executes the copying process under the settings in which the number of copies is “2”. Therefore, in a case where the authentication of the user having the user ID “bbbb” is permitted, the web contents change part 2314 changes the web contents, so that the initial setting value of the number of copies included in the operation screen of the copying process is changed to “2”.

The above-described changes by the web contents change part 2314 are performed on corresponding setting buttons “color settings”, “number of copies”, “aggregate printing” and “staple settings”. Note that the items “color settings”, “number of copies”, “aggregate printing” and “staple settings” are examples of the setting items pertaining to the copying process included in the operation screen of the copying process.

Accordingly, the web contents change part 2314 can change the web contents in the setting screen of the copying process displayed based on the web contents, so that the settings of the copying process are changed to settings frequently used by the user.

### <Functional Configuration of Image Forming Apparatus>

The image forming apparatus 110 includes, for example, a wireless communication part 2321, an authentication request part 2322, a contents process part 2323, and an operation history transmission part 2324 instead of the web browser part 410 included in the functional configuration of the image forming apparatus 110-1 illustrated in FIG. 4. Other parts of the configuration of the image forming apparatus 110 are substantially the same as those of the configuration of the image forming apparatus 110-1 illustrated in FIG. 4. Therefore, the differences between the image forming apparatus 110 of the sixth embodiment and the image forming apparatus 110 illustrated in FIG. 4 are mainly described below.

The wireless communication part 2321 is a part that communicates with the information terminal 140 by wireless communications such as wireless LAN, wireless PAN, infrared communication, and soundwave communication. For example, the wireless communication part 2321 is implemented by the wireless communication apparatus 311 of FIG. 3 and a program executed by the CPU 301 of FIG. 3. Note that the wireless communication part 2321 is not limited to perform wireless communication. That is, the wireless communication may communicate with the information terminal by way of cable (wired) communication.

The authentication request part 2322 is a part that requests the server apparatus 120 to authenticate a user by using the user's authentication information (e.g., user ID, password) obtained from the information terminal 140. For example, the authentication request part 2322 is implemented by a program executed by the CPU 301 of FIG. 3.

The contents process part 2323 obtains web contents provided by the server apparatus 120 and provides the obtained web contents to the information terminal 140.

The operation history transmission part 2324 transmits operation history of the image forming processes executed by the image forming unit 420 (e.g., history of copying processes executed by the image forming unit 420) to the server apparatus 120 according to operations performed on the information terminal 140. The operation history transmitted by the operation history transmission part includes, for example, information such as “process content”, “user ID”, “color settings”, “number of copies”, “aggregate printing”, and “staple settings” included in the operation history illustrated in FIG. 24B.

### <Functional Configuration of Image Forming Apparatus>

The information terminal 140 of the sixth embodiment includes a wireless communication part 2331 and the web browser part 410 included in the functional configuration of the image forming apparatus 110-1 illustrated in FIG. 4.

In the example of FIG. 4, the web browser part 410 is implemented by the operation part 306 included in a computer or program executed by the CPU 301 of the image forming apparatus 110. However, according to the sixth embodiment, the web browser part 410 is implemented by a program of a web browser executed by the CPU (e.g., CPU 201 of FIG. 2) of the information terminal 140.

The obtaining part 411 of the web browser part 410 according to the sixth embodiment obtains web contents from the image forming apparatus 110. The obtained web contents includes, for example, information pertaining to the operation screen of the copying process along with a script for controlling the copying process or reference information of a script for controlling the copying process. Note that the other configurations of the web browser part 410 are substantially the same as those of the web browser part 410 illustrated in FIG. 4.

The wireless communication part 2331 is a part that communicates with the image forming apparatus 110 by the above-described wireless communication (or wired communication) of the wireless communication part 2321 of the image forming apparatus 110. For example, the wireless communication part 2331 is implemented by the wireless communication apparatus 211 of FIG. 2 and the program executed by the CPU 301 of FIG. 2.

According to the above-described configuration, the web browser part 410 of the information terminal 140 can obtain web contents pertaining to the operation screen of the copying process from the image forming apparatus 110 and display the operation screen of the copying process on the display device 207 of the information terminal 140 by using the obtained web contents. Further, the web browser part 410 of the information terminal 140 transmits (requests) the controlling of the copying process to the image forming apparatus 110 by executing the script of the web contents corresponding to the operation performed on the operation screen of the display device 207 by the user.

### <Flow of Image Forming Method>

Next, an example of the flow of an image forming method of the image forming system 2300 is described.

### <Copying Process>

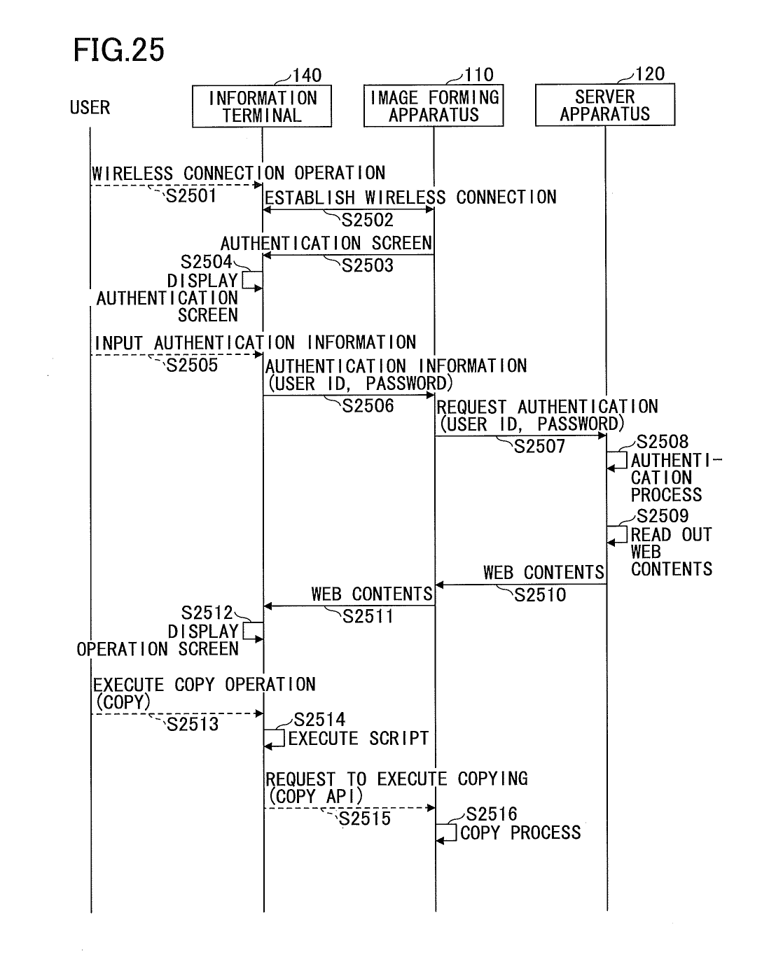

FIG. 25 is a sequence diagram illustrating an example of a copying process according to the sixth embodiment of the present invention.

First, the user using the image forming apparatus 110 with the information terminal 140 performs an operation for establishing wireless connection between the information terminal 140 and the image forming apparatus 110 (Step S2501). For example, the user establishes the wireless communication by validating the wireless function (e.g., wireless LAN function, Bluetooth function) of the information terminal or inputting wireless communication information.

Then, wireless connection is established between the information terminal 140 and the image forming apparatus 110, so that communication can be performed between the information terminal 140 and the image forming apparatus 110 (Step S2502).

Then, the authentication request part 2322 of the image forming apparatus 110 provides an authentication screen to the information terminal 140 (Step S2503). Further, the display control part 414 of the information terminal 140 instructs the display device 207 to display the authentication screen obtained from the image forming apparatus 110 (Step S2504).

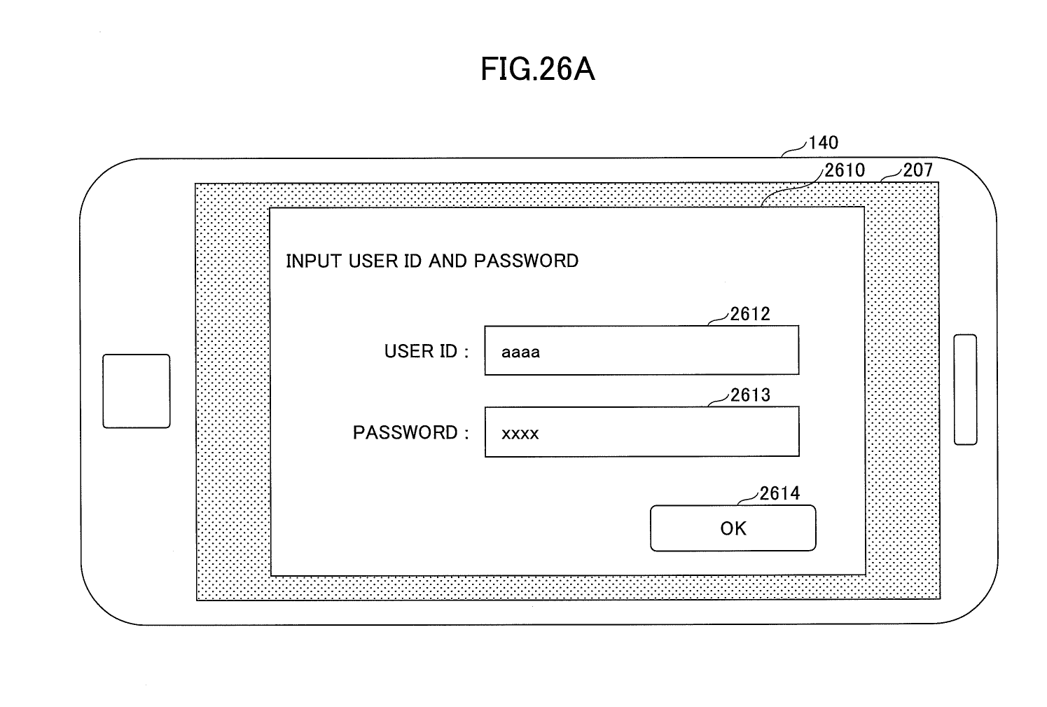

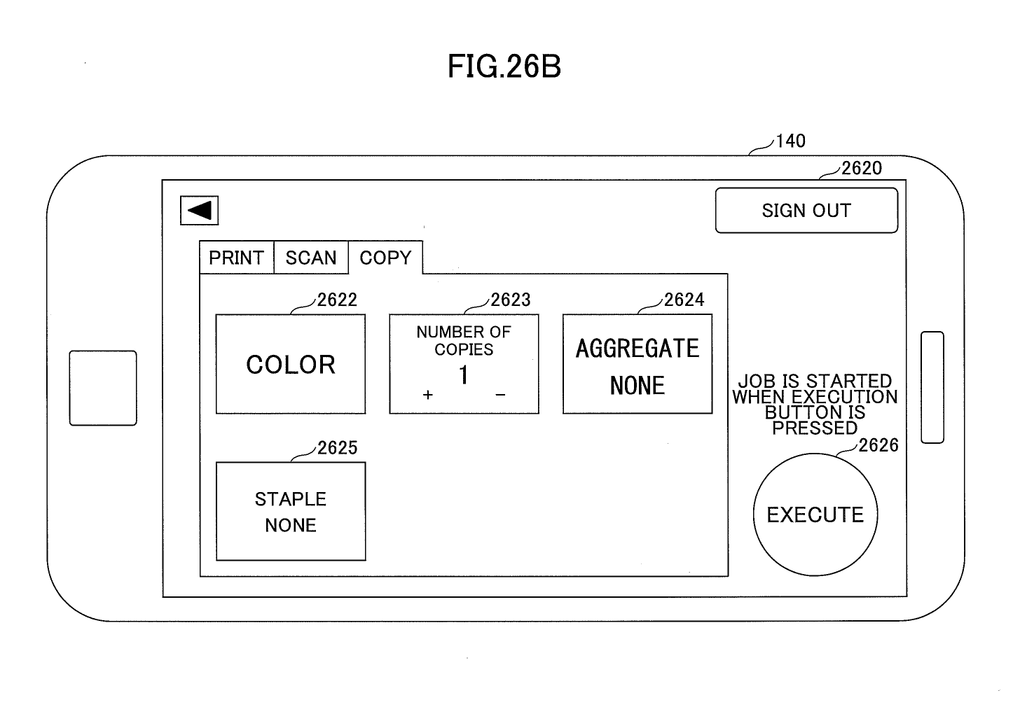

For example, the authentication request part 2322 having the function of a web server instructs the web browser part 410 of the information terminal 140 to display the authentication screen 2610 as illustrated in FIG. 26A. In the example of FIG. 26A, the authentication screen 2610 is displayed in the display device 207 of the information terminal 140. Further, an input space 2612 for inputting a user ID, an input space 2613 for inputting a password, and an “OK” button 2614 is displayed in the authentication screen 2610.

Then, the user inputs authentication information to the information terminal 140 (Step S2505). For example, the user performs the authentication information inputting process by inputting a user ID to the user ID input space 2612 and a password to the password input space 2613 displayed on the authentication screen 261 as illustrated in FIG. 26A and selecting the “OK” button 1614.

When the information terminal 140 receives the authentication information input by the user, the information terminal 140 transmits the user ID and password included in the authentication information to the image forming apparatus 110 (Step S2506).

When the authentication request part 2322 of the image forming apparatus 110 receives the user ID and password transmitted from the information terminal 140, the image forming apparatus 110 transmits an authentication request to the server apparatus 120 for requesting authentication of the received user ID and password (Step S2507).

Then, the authentication part 2311 of the server apparatus 120 performs an authentication process on the user ID and password included in the authentication request transmitted from the image forming apparatus 110 (Step S2508). For example, the authentication part 2311 allows authentication of the user in a case where the combination of the user ID and password included in the authentication request are included in the authentication information stored in the storage part 2312. Alternatively, the authentication part 2311 denies (or ignores) authentication of the user in a case where the combination of the user ID and password included in the authentication request are not included in the authentication information stored in the storage part 2312.

The image forming method is further described assuming that the authentication part 2311 allows the authentication of the user.

The web contents management part 452 of the server apparatus 120 reads out web contents pertaining to the operation screen of the copying process from the web contents storage part 451 (Step S2509).

Then, the web contents management part 452 of the server apparatus 120 transmits (provides) the web contents to the image forming apparatus (that has transmitted the authentication request) via the communication unit 440 (Step S2510).

When the contents process part 2323 of the image forming apparatus 110 receives the web contents from the server apparatus 120, the image forming apparatus 110 transmits the web contents to the information terminal (Step S2511).

Then, the obtaining part 411 of the information terminal 140 obtains the web contents transmitted from the image forming apparatus 110 (Step S2512). Further, the display control part 414 of the information terminal 140 displays the operation screen of the copying process on the display device 207 of the information terminal 140 based on the web contents obtained from the obtaining part 411. FIG. 26B illustrates an example of the operation screen of the copying process displayed by the display apparatus 207 of the information terminal 140.

In the example of FIG. 26B, the display device 207 of the information terminal 140 displays an operation screen 2620 of the copying process. The operation screen 2620 of the copying process includes various setting buttons such as a button 2622 for setting color/monochrome copying, a button 2623 for setting the number of copies, a button 2624 for setting aggregate printing style, and a button 2625 for setting a stapling function. Further, the operation screen 2620 of the copying process also displays an “execution” button 2626 for requesting the copying process to be executed.

The user performs an operation of requesting the execution of the copying process, for example, by selecting the execution button 2626 displayed in the operation screen 2620 of the copying process (Step S2513).

When the operation reception part 415 of the information terminal 140 receives the user's operation of the execution of the copying process, the script execution part 413 executes a script corresponding to the execution button 2626 included in the various scripts for controlling the copying process (Step S2514). Then, the script execution part 413 of the information terminal 140 transmits a copy execution request (copy API) to the image forming apparatus 110 via the wireless communication part 2331 for requesting the execution of the copying process (Step S2514).

When the image forming unit 420 of the image forming apparatus 110 receives the copy execution request (copy API) transmitted from the information terminal 140, the image forming unit 420 executes the copying process according to the copy execution request (Step S2516).

### <Another Example of Copying Process>

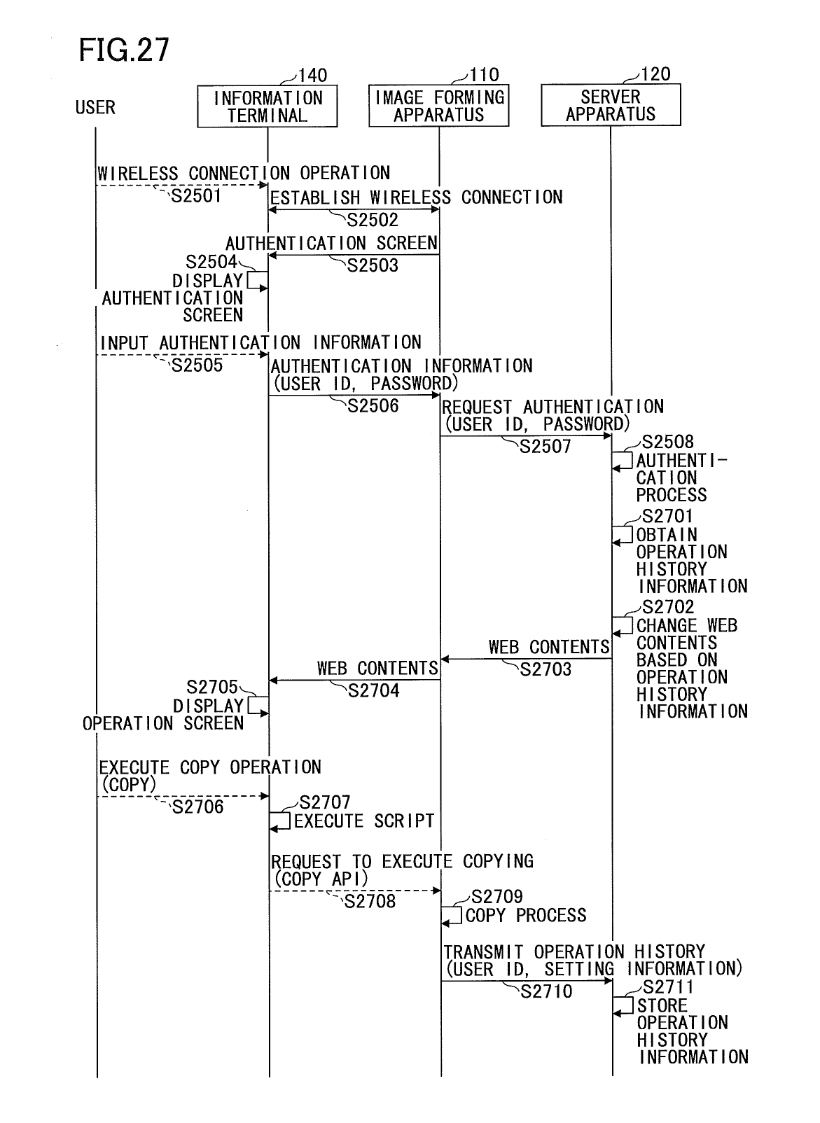

FIG. 27 is a sequence diagram illustrating another example of a copying process according to the sixth embodiment of the present invention. The processes of Steps S2501 to S2508 of FIG. 27 are substantially the same as the corresponding processes of FIG. 25. Therefore, the differences between the processes of FIG. 27 and the processes of FIG. 25 are mainly described below.

When authentication of the user is allowed in Step S2508, the web contents change part 2314 of the server apparatus 120 obtains operation history information (see, for example, FIG. 24B) from the operation history information management part 2313 (Step S2701).

Then, the web contents change part 2314 of the server apparatus 120 reads out web contents of the operation screen of the copying process from the web contents storage part 451 (Step S2702). Further, the web contents change part 2314 changes the web contents by using the user's user ID authenticated in Step S2508 and the operation history information obtained in Step S2701.

For example, the initial settings of the operation screen of the copying process in the web contents are assumed to have the settings in which the color settings is “color”, the number of copies is “1”, the aggregate printing setting is “none”, and the staple function setting is “none” as illustrated in FIG. 26B. Further, the user's user ID authenticated by the authentication part 2311 is assumed to “aaaa”.

In this example, the web contents change part 2314 obtains settings that are frequently used by the user having the user ID “aaaa” from the operation history information obtained in Step S2701. For example, the settings frequently used by the user having the user ID “aaaa” are determined to have the color setting of “monochrome”, the number of copies of “1”, the aggregate printing setting of “2 in 1”, and the staple function setting of “upper left” according to the operation history information illustrated in FIG. 24B.

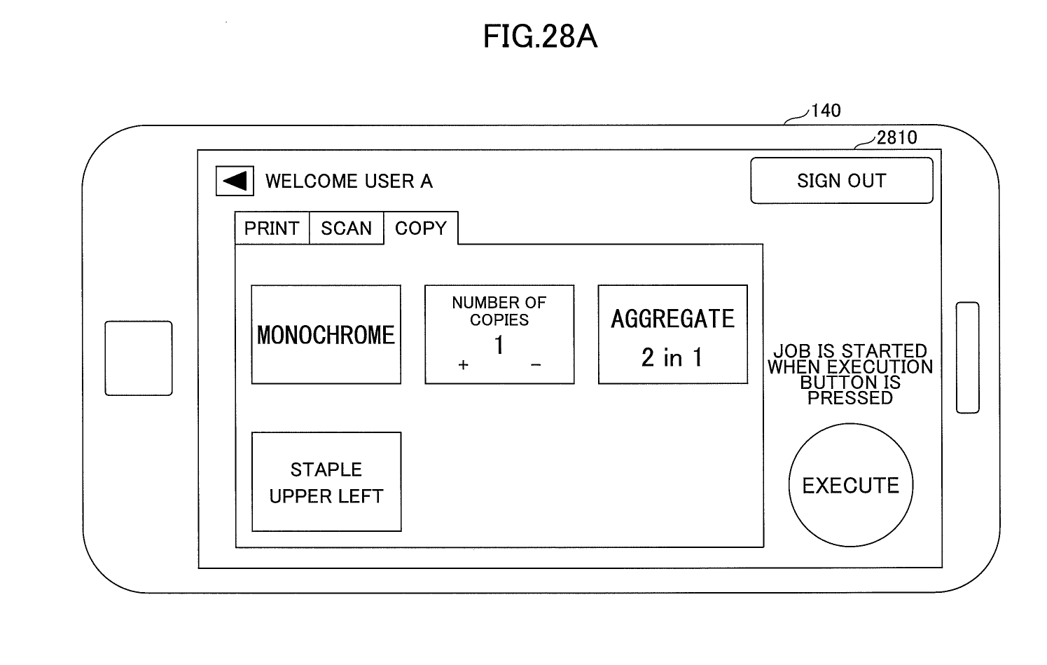

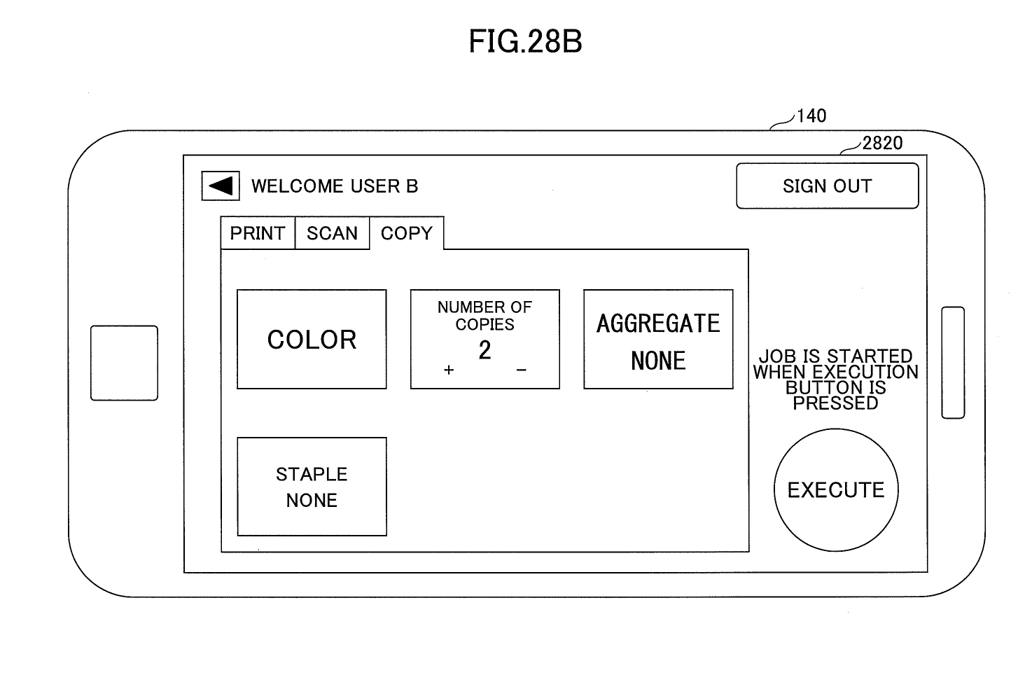

Accordingly, the web contents change part 2314 changes the web contents displayed in the operation screen 2620 of FIG. 26B to the web contents displayed in the operation screen 2810 of FIG. 28A. In the example of FIG. 28A, the settings are changed to the color setting of “monochrome”, the number of copies of “1”, the aggregate printing setting of “2 in 1”, the staple setting of “upper left. Accordingly, the changed settings are displayed on the operation screen 2810 to indicate the frequently used settings of the user having the user ID “aaaa”.

Similarly, in a case where the user's authenticated user ID authenticated by the authentication part 2311 is “bbbb”, the web contents change part 2314 obtains settings that are frequently used by the user having the user ID “bbbb” from the operation history information. In the example of FIG. 28B, the settings are changed to the color setting of “color”, the number of copies of “2”, the aggregate printing setting of “none”, the staple setting of “none”.

In this case, the web contents change part 2314 changes the web contents from, for example, the operation screen of the copying process of FIG. 26B to the web contents of the operation screen 2820 of FIG. 28B. In the example of FIG. 28B, the settings are changed to the color setting of “color”, the number of copies of “2”, the aggregate printing setting of “none”, the staple setting of “none”. Accordingly, the changed settings are displayed on the operation screen 2810 to indicate the frequently used settings of the user having the user ID “bbbb.”.

For example, the web contents change part 2314 of the server apparatus 120 changes the web contents based on the user's user ID authenticated by authentication part 2311 and the history information managed by the operation screen information management part 2313.

The image forming method is further described by referring back to FIG. 27.

The web contents management part 452 of the server apparatus 120 transmits (provides) the web contents changed by the web contents change part 2314 to the image forming apparatus 110 (that has transmitted the authentication request) via the communication unit 440 (Step S2703).

When the contents process part 2323 of the image forming apparatus 110 receives the web contents from the server apparatus 120, the image forming apparatus 110 transmits the web contents to the information terminal (Step S2704).

Then, the obtaining part 411 of the information terminal 140 obtains the web contents transmitted from the image forming apparatus 110 (Step S2705). Further, the display control part 414 of the information terminal 140 displays the operation screen of the copying process on the display device 207 of the information terminal 140 based on the web contents obtained from the obtaining part 411. Accordingly, the operation screen of the copying process that has been changed with settings frequently used by each user can be displayed on the display device 207 of the information terminal 140 as illustrated in FIG. 28A or FIG. 28B.

Then, the user performs an operation of requesting the execution of the copying process, for example, by selecting the execution button in the operation screen 2810, 2820 of the copying process displayed by the information terminal 140 (Step S2706).

When the operation reception part 415 of the information terminal 140 receives the user's operation of the execution of the copying process, the script execution part 413 executes a script corresponding to the execution button included in the various scripts for controlling the copying process (Step S2707). Then, the script execution part 413 of the information terminal 140 transmits a copy execution request (copy API) to the image forming apparatus 110 via the wireless communication part 2331 for requesting the execution of the copying process (Step S2708).

When the image forming unit 420 of the image forming apparatus 110 receives the copy execution request (copy API) transmitted from the information terminal 140, the image forming unit 420 executes the copying process according to the copy execution request (Step S2709).

Then, the operation history transmission part 2324 of the image forming apparatus 110 transmits an operation history to the server apparatus 120 (Step S2710). The operation history transmitted to the server apparatus 120 may include, for example, the user ID of the user requesting the copying process executed in Step S2709 and setting information pertaining to the settings used in the copying process.

For example, the operation history transmission part 2324 obtains log information of the authentication requesting process of Step S2507 from the authentication request part 2322 and identifies the user ID of the user. Further, the operation history transmission part 2324 obtains the log information of the copying process of Step S2709 from the image forming unit 420 and identifies the setting information of the copying process (e.g., color settings, number of copies, aggregate printing settings, staple settings).

When the operation history information management part 2313 of the server apparatus 120 receives the operation history from the image forming apparatus 110, the operation history information management part 2313 stores the received operation history as operation history information as illustrated in FIG. 24B and manages the operation history information (Step S2711).

According to the above-described processes, the server apparatus 120 can manage the operation history of each user and change the web contents based on the operation history, so that the settings of the operation screen are set to be settings that are frequently used by the user.

More specifically, according to the sixth embodiment of the present invention, there is provided an image forming system including a server apparatus, an image forming apparatus connected to the server apparatus via a network, and an information terminal that can communicate with the image forming apparatus. The server apparatus includes a storage unit that stores web contents including information of an operation screen of a copying process of the image forming apparatus and information of a script for controlling the copying process, and a management unit that provides the web contents to the image forming apparatus. The image forming apparatus includes a contents process part that provides the web contents obtained from the server apparatus to the information terminal, and an image forming part that includes an interface for receiving a request from the information terminal and configured to perform the controlling of the copying process in response to the request received from the information terminal. The information terminal includes a display control part that displays the operation screen of the copying process on a display part based on the web contents obtained from the image forming apparatus, and a script execution part that executes the script for controlling the copying process based on the web contents from the image forming apparatus.

According to an aspect of the image forming system of the sixth embodiment, the server apparatus further includes an operation history information management part that manages operation history information. In the operation history information, user identification information for identifying a user is stored in, for example, the storage part, in association with history information pertaining to the user's history of the copying process. The server apparatus further includes a change part that changes the web contents obtained from the management part based on the user identification information and the operation history information of the user using the information terminal to use the image forming apparatus.

According to an aspect of the image forming system of the sixth embodiment, the change part of the server apparatus is configured to change the operation screen of the copying process according to the web contents, so that the settings pertaining to the copying process are set as settings items that are frequently used.

With the image forming system according to the above-described embodiments, the server apparatus 120 can store and provide web contents including information pertaining to the operation screen of the copying process along with a script for controlling the copying process or reference information of a script for controlling the copying process.

Further, the web browser part 410 of the image forming apparatus 110 can obtain web contents provided by the server apparatus 120 and display the operation screen of the copying process on the operation part 306 based on the obtained web contents.

Further, the image forming unit 420 of the image forming apparatus has an interface (API control part 421) that receives various API for controlling the copying process by way of the web browser part 410. Thereby, the image forming unit 420 can execute the copying process according to the received APIs.

Further, with the image forming system 100 according to the above-described embodiments, the operation screens of multiple image forming apparatuses 110-1, 110-2 can be easily changed by updating the web application 121 of the server apparatus 120.

Further, with the image forming system 100 according to the above-described embodiments, the web browser part 410 of the image forming apparatus 110 can execute the copying process can execute the script included in the web contents within the range of image forming apparatus 110. Thereby, the image forming apparatus 110 can execute the copying process without having to transmit read out image data to the server apparatus 120. Accordingly, processing rate for executing the copying process can be prevented from decreasing.

Further, with the image forming system 100 (including multiple image forming apparatuses 110-1, 110-2) according to the above-described embodiments, the processing rate can be prevented from decreasing and the operation screen of the copying process can be easily changed for each of the image forming apparatuses 110-1, 110-2.

The present invention is not limited to the specifically disclosed embodiments, and variations and modifications may be made without departing from the scope of the present invention.

What is claimed is:

1. An image forming apparatus comprising:
a plurality of hardware resources including at least a scanner device and a printer device;
a user interface including a display;
a network interface configured to connected to a server apparatus via a network; and
a processor that causes the image forming apparatus to execute processes of a web browser unit and an image forming unit;
wherein the web browser unit includes
an obtaining part that obtains web contents from the server apparatus, the web contents including screen information pertaining to an operation screen of a copying process that uses the scanner device and the printer device and script information pertaining to a script for controlling the copying process,
a display control part that displays the operation screen of the copying process on the display based on the web contents obtained by the obtaining part, and
a script execution part that executes the script for controlling the copying process based on the script information included in the web contents obtained by the obtaining unit,
wherein the image forming unit includes an interface for receiving a request for controlling the copying process by the execution of the script for controlling the copying process by the script execution part, and
wherein the image forming unit is configured to control the copying process in response to the request received by the interface.

2. The image forming apparatus as claimed in claim 1,
wherein the script includes a capability information obtaining script from the image forming unit,
wherein the capability information obtaining script is a script for obtaining capability information pertaining to a function that can be executed by the image forming unit, and
wherein the display control part is configured to display the operation screen in accordance with the information pertaining to an operation screen of a copying process and the capability information obtained from image forming unit.

3. The image forming apparatus as claimed in claim 1,
wherein the script for controlling the copying process includes a status information obtaining script for obtaining a status information of the copying process from the image forming unit, and
wherein the display control part is configured to display the operation screen including the status information of the copying process on the operation screen.

4. The image forming apparatus as claimed in claim 1,
wherein the script for controlling the copying process includes a setting information obtaining script for obtaining setting information pertaining to the copying process from the image forming unit, and
wherein the display control part is configured to display the operation screen including the setting information pertaining to the copying process on the operation screen for changing the setting information pertaining to the copying process.

5. The image forming apparatus as claimed in claim 1,
wherein the operation screen includes a user interface allowing one or more processes pertaining to the copying process to be selected, and
wherein the script execution part is configured to execute a script included in the scripts for controlling the copying process,
wherein the script corresponds to the one or more processes selected from the user interface.

6. The image forming apparatus as claimed in claim 5, wherein the one or more processes include starting the copying process.

7. The image forming apparatus as claimed in claim 5, wherein the one or more processes include stopping or canceling the copying process.

8. The image forming apparatus as claimed in claim 5, wherein the one or more processes include changing a setting value of the copying process.

9. The image forming apparatus as claimed in claim 1,
wherein the interface of the image forming unit is a web API,
wherein the script for controlling the copying process uses the web API to request controlling of the copying process.

10. The image forming apparatus as claimed in claim 1, wherein the script for controlling the copying process includes controlling the copying process within a range of the image forming apparatus.

11. The image forming apparatus as claimed in claim 1, wherein the information of the script includes a first script for controlling the copying process.

12. The image forming apparatus as claimed in claim 1, wherein the information of the script includes reference information of a second script for controlling the copying recess.

13. An image forming system comprising:
one or more image forming apparatuses including a plurality of hardware resources including at least a scanner device and a printer device, a user interface including a display, and a network interface; and
a server apparatus connected to the network interface of the one or more image forming apparatus via a network;
wherein the server apparatus includes
a storage unit that stores web contents including screen information pertaining to an operation screen of a copying process that uses the scanner device and the printer device and script information pertaining to a script for controlling the copying process, and
a management unit that provides the web contents to the image forming apparatus in response to a request from the image forming apparatus, the web contents include an obtaining part that obtains the web contents from the server apparatus;
wherein one of the one or more image forming apparatuses includes
a web browser part including
an obtaining part that obtains the web contents from the server apparatus,
a display control part that displays the operation screen of the copying process on the display based on the web contents obtained by the obtaining unit, and
a script execution part that executes the script for controlling the copying process based on the script information included in the web contents obtained by the obtaining unit, and
an image forming unit including an interface for receiving a request for controlling the copying process by the execution of the script for controlling the copying process by the script execution part.

14. An image forming method for a system including one or more image forming apparatuses and a server apparatus connected to the one or more image forming apparatus including at least a scanner device, a printer device, and a display via a network, the method comprising:
requesting the server apparatus to provide web contents stored in the server apparatus by way of a web browser of the one or more image forming apparatus, the web contents including screen information pertaining to an operation screen of a copying process that uses the scanner device and the printer device and script information pertaining to a script for controlling the copying process;
providing the web contents in response to the request from the one or more image forming apparatus;
displaying an operation screen of a copying process on the display of the one or more image forming apparatuses based on the web contents;
receiving a request for controlling the copying process by way of an interface of the one or more image forming apparatuses; and
controlling the copying process by executing a the script for controlling the copying process based on the script information included in the web contents obtained from the server apparatus.
